(19) United States
(12) Patent Application Publication
(10) Pub. No.: US 2007/0054716 A1
(43) Pub. Date: Mar. 8, 2007

(54) Network game system, client device and server apparatus

(75) Inventor: Kenji Hiruta, Kanagawa (JP)

Correspondence Address: VENABLE LLP, P.O. BOX 34385, WASHINGTON, DC, 20043-9998, US

(73) Assignee: Kabushiki Kaisha Koei, Kanagawa (JP)

(21) Appl. No.: 11/347,232

(22) Filed: Feb. 6, 2006

(30) Foreign Application Priority Data
Sep. 8, 2005 (JP) 2005-260877
Oct. 26, 2005 (JP) 2005-311813

(51) Int. Cl. A63F 13/00

(52) U.S. Cl. 463/1

(57) ABSTRACT

At each of game consoles connected to a network game system, character information and relegated character information are stored at a storage unit. An arithmetic operation unit determines through arithmetic operations the extent of changes in the position and motion of each of the relegated characters as the game progresses based upon the character information stored at the storage unit. A communication unit transmits a character information packet having the calculated character information to a game server. The game server transmits the received character information packet to the other game consoles participating in the game. At each of the other game consoles, the received character information is stored and an image of the relegated character reflecting the changes is generated. Thus, the executions of the processing and management of the various characters taking part in the game are distributed.

### CROSS REFERENCE TO RELATED APPLICATION

The disclosures of Japanese Patent Application No. JP 2005-311813 filed on Oct. 26, 2005 and No. JP 2005-260877 filed on Sep. 8, 2005 are incorporated herein by reference in their entirety.

### BACKGROUND OF THE INVENTION

1. Field of the Invention

The present invention relates to a method for distributing processing related to a plurality of characters in a game over a plurality of devices in a network game system. More specifically, it relates to a method for distributing over a plurality of devices processing the management of a plurality of characters in a network game system in which opposing teams made up of individual characters combat one another, so as to facilitate smooth team functioning.

2. Description of the Related Art

The advent of broadband technology in recent years has led to an exponential increase in the number of Internet users and further evolution of communication technologies. It has also resulted in the tremendous popularity of network games that allow simultaneous participation by a plurality of players via a network. Such network games include real-time competition game systems typically played by a plurality of game players participating via a network with a plurality of assigned teams, in which the plurality of teams compete against one another in combat via the network (see, for instance, Japanese laid Open Patent Publication No. 2001-353375).

In such a network game system, the “server•client method” whereby all the characters in the game are controlled through centralized management executed on the server side is normally adopted. Namely, in a network system adopting this system, a dedicated server to function as the central host machine is engaged in centralized management of the main execution of the actual game program, the entire game data and the virtual space shared by the individual client devices, and the game is played as the dedicated server exchanges game commands and the like with the client devices.

In the network system, as a game player enters an action through a key input at a client device, the server first receives the data entered through the key input, executes all the necessary processing and transmits the graphic drawing information alone to the client device. Only then is the action corresponding to the key input operation by the game player brought up on display. Since the character on the screen does not immediately respond to the game player's operation, the playability of the game is compromised and due to the poor playability, the game player may find the game not as engrossing as it could be

There is another method, the “P2P (peer-to-peer) host method” adopted in network game systems. In this method, one of the client devices is designated as a host machine, which engages in direct communication with other client devices connected to the network as the game is played. In this case, a heavy processing load is placed on the client device functioning as the host machine, which is bound to delay the action of the character on the screen taken in response to a game player operation. Thus, the problems discussed above remains when the P2P host method is adopted.

More specifically, if a complex action game currently played in a standalone configuration, in which more than a hundred characters simultaneously take part in team combat competition, is to be adopted in a network game system, the hundred or more characters will need to react instantaneously to the game player's inputs. However, the volume of data that must be communicated, including the character data and the motion data, is bound to be extremely large when the game is managed at adopting either of the methods in the related art, resulting in significant delays in the action processing. Under such circumstances, the game cannot be offered as viable entertainment.

Accordingly, an object of the present invention is to provide a network game system with a plurality of characters taking part, a client device and a server apparatus, in conjunction with which processing and management of the individual characters are distributed for execution in order to assure smooth operations in the game environment.

### SUMMARY OF THE INVENTION

The object described above is achieved in an aspect of the present invention by providing a network game system in which a plurality of characters, including a plurality of player characters manipulated in correspondence to information input by a plurality of users each operating a client device connected to a server apparatus via a network and a plurality of computer characters whose actions are computer-manipulated, take part.

The client devices in this network game system each include a storage unit in which character information including position information indicating the positions of the plurality of characters is stored and computer characters to be managed at the subject client device among the computer characters are registered as relegated characters, an arithmetic operation unit that obtains through arithmetic operation updated character information indicating the extent of change occurring in the position of a relegated character and the extent of change occurring in the motion of the relegated character in correspondence to each of the relegated characters by using the character information stored at the storage unit as the game progresses, and a communication unit that transmits the updated character information corresponding to each relegated character having been obtained through the arithmetic calculation to the server apparatus as a character information packet.

The server apparatus receives the character information packet having been transmitted thereto and then transmits the received character information packet to other client devices participating in the game. The other client devices, in turn, receive the transmitted character information packet and store updated character information based upon the received character information.

In this system, the extents of change occurring in the position, and the motion of each of the relegated characters managed at a given client device as the game progresses are determined through arithmetic operations at the client device. Thus, the main processing executed to carry on the game, the load of which has so far been placed on the server apparatus, can be shared among the plurality of client devices participating in the game and, at the same time, the volumes of data exchanged between the server apparatus and the client devices can be minimized. As a result, a plurality of characters on the screen can be reacted instantly in response to the game player's operations. Consequently, a highly operable, engrossing game that provides players connected via a network a sense of real-time participation is achieved.

The client devices may each further may include a decision-making unit that determines, based upon the extent of change in the position of each relegated character having been calculated, a positional relationship among the calculated position of the relegated character, the position of the player character managed at the subject client device and the position of a player character managed at another client device and makes a decision as to whether or not the relegated character is to be managed at the subject client device based upon the positional relationship thus determined. In this case, the registration of the relegated character at the storage unit of the client device may be cleared if the decision-making unit decides that the relegated character is to be no longer managed at the client device and the communication unit of the client unit may transmit a character management change packet containing character information for the relegated character to the server apparatus if the decision-making unit decides that the relegated character is to be managed at the other client device.

The server apparatus having received the character management change packet may then transmit the received character management change packet to the other client device. Upon receiving the character management change packet thus transmitted, the other client device may store the received character information and register the character specified by the received character information as a relegated character.

Through this procedure, the client device best suited to manage a computer character in correspondence to the current game progress condition is identified based upon the positional relationship among the positions of the relegated character, the position of the player character managed at the subject client device and the position of the player character managed at the other client device. By selecting the optimal client device to manage the computer character as the game progresses as described above, the processing sharing in the entire system is optimized to allow the game to be played more smoothly. It is to be noted that the term “management” in this context refers to processing such as coordinate calculation and motion reproduction for multiple computer characters involved in offensive and defensive moves executed by the individual client devices.

The present invention is particularly ideal in an application in a network game system that offers, for example, a fight game in which opposing teams made up of a plurality of characters including a plurality of player characters each managed at one of the plurality of client devices and computer characters that may, for instance, guard or assist player characters, combat one another. A great number of characters, typically 80 to 128 characters, simultaneously appear on the screen while such a team fight game is in progress. For this reason, it is crucial to achieve optimal processing sharing in order to avoid any delays in the game.

Alternatively, the network game system may be a system that offers another type of game in which a plurality of player characters each managed at one of the plurality of client devices and a plurality of computer characters work together as a team. A specific example of such a system is a social-climbing game system, in which the subject player character is manipulated to work in cooperation with a plurality of computer characters to improve parameters such as the rank, the skills and the like of the subject player character in competition against other player characters manipulated via other client devices connected through a network. The system may instead offer a game through which communication is provided as a form of entertainment as the player character manipulated by the subject game player, supported by a plurality of computer characters, engages in a chat with another player character via a network.

The object described above is achieved in another aspect of the present invention by providing a client device used to participate in a network game in which a plurality of characters, including a plurality of player characters each managed at one of a plurality of client devices connected via a network and a plurality of computer characters to play supporting roles for the plurality of player characters, take part. More specifically, this client device includes a storage unit in which character information including position information indicating the positions of the plurality of characters is stored and computer characters to be managed at the subject client device among all the computer characters are registered as relegated characters and an arithmetic operation unit that obtains through arithmetic operation updated character information indicating the extent of change occurring in the position of each relegated character and the extent of change occurring in the motion of a relegated character in correspondence to each of the relegated characters by using the character information stored at the storage unit as the game progresses.

The client device may further include an image generation unit that generates, based upon the character information having been generated, an image related to a character identified in the character information.

In this system, the client device calculates through arithmetic operation the extent of change in the position and in the motion of each of the relegated characters managed therein as the game progresses. Thus, the main processing executed to carry on the game, the load of which has so far been placed on the server apparatus, can be shared among the plurality of client devices participating in the game and, at the same time, the volumes of data exchanged between the server apparatus and the client devices can be minimized. Consequently, the game player is able to enjoy playing the game with a sense of real-time excitement and spontaneity while viewing the plurality of characters on the screen that react instantaneously to game player manipulation.

The client devices may each further include a decision-making unit that determines based upon the extent of change in the position of each relegated character having been calculated, a positional relationship among the calculated position of the relegated character, the position of the player character managed at the subject client device and the position of a player character managed at another client device and makes a decision as to whether or not the relegated character is to be managed at the subject client device based upon the positional relationship thus determined.

In this system, an optimal client device best suited to manage a computer character in the current game progress condition is identified based upon the positional relationship among the positions of the computer character, i.e., the relegated character, the position of the player character managed at the subject client device and the position of the player character managed at the other client device. In addition, the management of the individual computer characters is delegated to one of the client devices participating in the network game. By selecting the optimal client device to manage the computer character as the game progresses as described above, the processing sharing in the entire system is optimized to allow the game to be played more smoothly.

The decision-making unit may make a decision as to whether or not each of the relegated characters managed at the subject client device is to be managed at the subject client device based upon the positional relationship determined as described above, so that the management of the relegated character is delegated to a client device managing a player character present at a position within a predetermined range from the relegated character.

Alternatively, the decision-making unit may make a decision as to whether or not the relegated character is to be managed at the subject client device based upon the positional relationship determined as described above, so that the management of the relegated character is delegated with priority to a client device managing a player character assuming a role of an opponent to the relegated character.

If the network game system offers a team combat game, a player character does not attack ally computer characters. In other words, when a player character is manipulated in response to an input operation by the player, only the enemy computer characters near the player character needs to automatically respond to the action (attack) of the player character without depending upon the input operation by the game player. This means that only the arithmetic operation needs to determine the reaction of the enemy computer characters near the player character to the attack. For this reason, the management of the enemy computer characters is delegated with priority to the client device managing the player character having initiated the attack accordingly to the present invention. As a result, the subject client device is able to instantaneously calculate a value representing the change in the motion of the enemy computer character as well as that of the subject player character, and the results of the arithmetic operation can be immediately reflected on the screen display. Thus, it is ensured that the processing for appropriate reaction to the attack is executed without fail and the game player is able to enjoy an exciting and spontaneous game environment.

In addition, the decision-making unit may make a decision as to whether or not each relegated character is to be managed at the subject client device based upon the positional relationship determined as described above, so that the relegated character is managed at the client device managing a player character present at the position closest to the relegated character.

A computer character for which processing needs to be executed in response to an action of the player character manipulated by a game player to allow the game to advance to a subsequent stage is often present near the player character. For this reason, the management of a computer character in the vicinity of the player character is delegated with priority to the client device managing the player character, regardless of whether the computer character is an enemy character or an ally character, according to the present invention. As a result, the game can advance smoothly.

The decision-making unit may decide that a given relegated character is to be managed at the subject client device even when the position of the player character managed at the other client device is closest to the relegated character unless the player character managed at the other client device is closer to the relegated character than the player character managed at the subject client device by an extent equal to or greater than a predetermined distance.

By setting a predetermined margin (the predetermined distance) to be applied when switching the management of a relegated character as described above, the management of the relegated character is not switched too often. It is desirable to set the predetermined distance to a value that does not allow the decision-making unit to decide that the management of the relegated character should be switched with excessive frequency. In addition, a smaller value should be selected for the predetermined distance if the relegated character is an enemy to the player character managed at the other client device, relative to a value which should be set for the predetermined distance when the relegated character is an ally of the player character managed at the other client device. The decision-making unit may make a decision with regard to the management switch-over for each relegated character based upon a factor other than the distance. For instance, if computer characters are preassigned to specific client devices, the management may be switched in conformance to the assignment protocol.

Furthermore, the decision-making unit may make a decision as to whether or not each of the relegated characters is to be continuously managed based upon the positional relationship having been calculated through the arithmetic operation, regardless of whether the relegated character is an enemy or an ally to the player character managed at the subject client device.

Alternatively, the decision-making unit may decide that a given relegated character is to be managed at the other client device regardless of the positional relationship having been determined, if the player character managed at the other client device is an enemy to the relegated character and the player character managed at the subject client device and the player character managed at the other client device is present at a position within a predetermined range from the relegated character.

The client device may further include a communication unit that transmits to the server apparatus a character management change packet containing character information corresponding to a relegated character with regard to which the decision-making unit has determined that the relegated character is to be now managed at the other client device. In this case, the registration of the relegated character with regard to which the decision-making unit has determined that it should be managed at the other client device is cleared at the storage unit.

The communication unit described above may also receive a character management change packet transmitted from another client device connected to the server apparatus via the network. The character information contained in the received character management change packet may then be stored and a character specified by the character information may be registered as a relegated character at the storage unit.

In the system, the updated character information obtained through arithmetic operation executed by a client device is transmitted to another client device via the server apparatus, and in response, the other client devices each update the data at the storage unit thereof with the transmitted character information. Through this process, consistency of the data related to all the character information stored at all the client devices is assured.

In addition, if a plurality of other client devices are connected via the network, the player character managed at a first other client device among the other client devices is an enemy and the player character managed at a second other client device is an ally, the decision-making unit may make a decision as to whether or not the relegated character is to be managed at the subject client device based upon the positional relationship having been determined as described above, so that the management of the relegated character is delegated with higher priority to the first other client device than to the second other client device.

Moreover, the decision-making unit may make a decision as to whether or not the relegated character is to be continuously managed at the subject client device over predetermined time intervals. Or the decision-making unit may make the decision by interlocking with the timing with which the display screen used for game display is scanned. The screen scanning timing, as referred to in this context, is the timing with which a vertical retrace line interrupt occurs. While the predetermined time intervals may each last over 1/60 sec (16.6 milliseconds), which matches the vertical retrace line cycle at the monitor, the length of the predetermined time intervals does not need to match the timing of the screen scanning, and an appropriate length of time, e.g., 1/30 sec or 1/20 sec, may be set for the predetermined time intervals in correspondence to the processing load at the decision-making unit. It is to be noted that instead of making the decision for all the relegated characters over the predetermined intervals, and instead, all the relegated characters may be divided into groups of relegated characters, and the decision-making unit may make a decision for only one group of relegated characters at a time after each interval.

The object described above is achieved in yet another aspect of the present invention by providing a server apparatus that manages a network game in which a plurality of characters including a plurality of player characters and a plurality of computer characters playing supporting roles to the plurality of player characters take part.

More specifically, the server apparatus includes a storage unit at which position information indicating the positions of the plurality of characters managed at a plurality of client devices connected to a network and identification information used to identify the specific client devices managing the individual characters are stored, a decision-making unit that determines based upon the position information contained in the character information and the identification information used to identify the individual client devices managing the computer characters, a positional relationship among the positions of the player characters managed at each client device and the position of a computer character managed at the client device and makes a decision with regard to the client device best suited to be delegated to manage the computer character based upon the positional relationship having been determined, and a communication unit that transmits a character management change packet to the client device having been determined to be delegated to manage the computer character.

In this case, the entire character management switch-over processing is executed at the server apparatus and the results of the switch-over processing are transmitted all at once to the individual client devices. Theoretically, this means that substantially equal delays occur at the individual client devices in the management switch-over processing, as long as the communication environment including the distances from the server apparatus to the individual client devices and the performance levels of the client devices are uniform and no communication failure occurs. Thus, numerous characters on the screens can be manipulated in an even more natural manner. Furthermore, since the management switchovers for all the characters are executed on the server side, the consistency of the data can be sustained easily and accurately. The only delays occurring when switching the character management are attributable to the length of time required for the communication with the client devices initiated by the server apparatus. As a result, an advantage is achieved in that communication delays occur to a lesser extent compared with the extent of communication delays that are bound to occur when the character management switch-over processing is executed at the client devices (when the character management switch-over processing is executed at the client devices, a greater length of time is required since the communication between the current custodian client device and the new custodian client device is enabled via the server. Namely, the length of time required for communication in this case is almost double the length of communication time required when the management switch-over processing is executed on the server side). It is to be noted that the identification information used to identify the client device managing a given character may be, for instance, preregistered client numbers assigned to the custodian client device.

In yet another aspect of the present invention, the object described earlier is achieved by providing a character management program that enables a computer to execute a network game in which a plurality of characters including a plurality of player characters manipulated in response to information input by a plurality of users each operating a client device connected to a network and a plurality of automatically-manipulated computer characters take part.

More specifically, a character management program that enables the computer to execute processing for individually storing into a storage unit of each client device character information containing position information indicating the positions of the plurality of characters, processing for individually registering each computer character among the computer characters to be managed at the subject client device as a relegated character at the storage unit of the client device, and processing for obtaining through an arithmetic operation updated character information for the subject client device, which indicates the extent of change in the position and in the motion of each relegated character as a game progresses based upon the character information stored at the storage unit of the client device.

The character management program described above may further engage the computer to execute processing for determining based upon the extent of change in the position of each relegated character, a positional relationship among the calculated position of the relegated character, the position of the player character managed at the subject client device and the position of the player character managed at another client device and determining the client device that is to manage the relegated character based upon the positional relationship, processing for clearing at the storage unit of the subject client device the registration of a relegated character with regard to which the management is determined to be delegated to the other client device, and processing for transmitting to a server apparatus a character management change packet containing the character information corresponding to the relegated character with regard to which the management has been determined to be delegated to the other client device.

The object described above is also achieved in yet another aspect of the present invention by providing a computer-readable storage medium having stored therein a character management program that enables a computer to execute a network game in which a plurality of characters including a plurality of player characters manipulated in response to information input by users each operating one of a plurality of client devices connected to a network and a plurality of automatically-manipulated computer characters take part.

The computer-readable storage medium having stored therein the character management program described above that enables a computer to execute processing for individually storing into a storage unit of each client device character information containing position information indicating the positions of the plurality of characters, processing for individually registering each computer character among the computer characters to be managed at the subject client device as a relegated character at the storage unit of each client device and processing for obtaining through an arithmetic operation updated character information for the subject client device, which indicates the extent of change in the position and in the motion of the relegated character as the game progresses based upon the character information stored at the storage unit of each client device.

The character management program stored in the computer-readable storage medium may enable the computer to execute processing for determining based upon the extent of change in the position of each relegated character, a positional relationship among the calculated position of the relegated character, the position of the player character managed at the subject client device and the position of the player character managed at another client device and determining the client device that is to manage the relegated character based upon the positional relationship, processing for clearing at the storage unit of the subject client device the registration of a relegated character with regard to which the management is determined to be delegated to the other client device, and processing for transmitting to a server apparatus a character management change packet containing the character information corresponding to the relegated character with regard to which the management has been determined to be delegated to the other client device.

Such a program each client device determines through arithmetic operation the extent of change in the position and in the motion of each of the relegated characters managed therein as the game progresses. Thus, the main processing executed to carry on the game can be shared among the plurality of client devices participating in the game, and, at the same time, the volumes of data exchanged between the server apparatus and the client devices can be minimized. As a result, a plurality of characters on the screen can be manipulated instantly in response to the game player's operations. Consequently, a highly operable, engrossing game that provides players connected via a network with a sense of real-time participation is achieved.

The object described above is also achieved in another aspect of the present invention by providing a network game system in which a plurality of characters including a single player character or a plurality of player characters manipulated in response to information input through user operations of a single client device or a plurality of client devices connected to a server apparatus via a network and a plurality of automatically-manipulated computer characters take part.

The client devices in this network game system each include a storage unit in which character information including position information indicating the positions of the plurality of characters is stored and computer characters to be managed at the subject client device among all the computer characters are registered as relegated characters, an arithmetic operation unit that obtains through arithmetic operation updated character information indicating the extent of change occurring in the position of a relegated character and the extent of change occurring in the motion of the relegated character in correspondence to each of the relegated characters by using the character information stored at the storage unit as the game progresses, and a communication unit that transmits the updated character information corresponding to each relegated character having been obtained through the arithmetic calculation to the server apparatus as a character information packet. The server apparatus in the network game system receives the character information packet having been transmitted thereto and then transmits the received character information packet to other client devices participating in the game. The other client devices, in turn, each receive the transmitted character information packet and store the updated character information based upon the received character information.

The server apparatus in this system may include a storage unit in which character information including the position information indicating the positions of the plurality of characters is stored and computer characters to be managed at the server apparatus among the computer characters are registered as relegated characters, an arithmetic operation unit that obtains through arithmetic operation updated character information indicating the extent of change occurring in the position of a relegated character and the extent of change occurring in the motion of the relegated character in correspondence to each of the relegated characters by using the character information stored at the storage unit as the game progresses, and a communication unit that transmits the updated character information corresponding to each relegated character having been obtained through the arithmetic calculation to all the client devices participating in the game as a character information packet.

In this case, even when there are not enough users participating in the game (e.g., even when only a single user is playing the game), any player character and the computer characters attendant to the player character not being played by a participating user are automatically manipulated by the server apparatus. As a result, even if only a few participants are involved in the game, the participating users can fully enjoy the game. In addition, by grouping characters to be managed at each client device separately from the characters to be managed at the server apparatus, the processing in the whole system can be shared so as to allow the game to carry on smoothly. It is to be noted that the server apparatus may automatically manipulate a plurality of player characters.

The plurality of characters taking part in the game may further include a single server character or a plurality of server characters automatically manipulated under control executed by the server apparatus. In this case, the server apparatus should further include a decision-making unit that determines, based upon the extent of change in the position of each relegated character having been calculated through the arithmetic operation as described above, a positional relationship among the calculated position of the relegated character, the position of one of the server characters managed at the server apparatus and the position of the player character managed at a client device or the position of another server character and makes a decision based upon the positional relationship thus determined whether or not to manage the relegated character in correspondence to the one server character.

The registration of a relegated character with regard to which the decision-making unit of the server apparatus has determined that the relegated character is no longer to be managed at the server apparatus may be cleared at the storage unit of the server apparatus. Accordingly, the communication unit of the server apparatus may transmit a character management change packet containing character information corresponding to the relegated character to the client device to which the decision-making unit of the server apparatus has decided to delegate management of the relegated character and upon receiving the character management change packet thus transmitted, the client device may store the received character information and register the character identified in the received character information as a relegated character thereof.

In this case, a decision as to whether or not the management of a given relegated character currently managed at the server apparatus is to be switched to another device is made by the server apparatus in correspondence to a server character. If a plurality of server characters are managed at the server apparatus, information on each server character and information on relegated characters (computer characters) making up a squad belonging to the server character are stored at the storage unit and the information at the storage unit is constantly updated.

The network game system may offer a combat game played by a single player character or a plurality of player characters managed at the single client device or the plurality of client devices and a single computer character or a plurality of computer characters aiding the single or the plurality of player characters, which make up an ally team, and a single server character or a plurality of server characters managed at the server apparatus and a single computer character or a plurality of computer characters aiding the server characters, which make up at least either an enemy team or an ally team.

In yet another aspect of the present invention, the object described above is achieved by providing a character management program that enables a computer to execute a network game in which a plurality of characters, including a single player character or a plurality of player characters manipulated in response to information input through user operations of a single client device or a plurality of client devices connected to a server apparatus via a network and a plurality of automatically-manipulated computer characters, take part.

The character management program may engage the computer to execute processing for individually storing into a storage unit of each client device character information containing position information indicating the positions of the plurality of characters, processing for individually registering each computer character among all the computer characters to be managed at the subject client device as a relegated character at the storage unit of each client device and processing for obtaining through an arithmetic operation updated character information for the subject client device, which indicates the extent of change in the position and the motion of each relegated character as the game progresses based upon the character information stored at the storage unit of the client device.

The character management program may also engage the computer to execute processing for individually storing into a storage unit of the server apparatus character information containing the position information indicating the positions of the plurality of characters, processing for individually registering each computer character among the computer characters to be managed at the server apparatus as a relegated character at the storage unit of the server apparatus and processing for obtaining through an arithmetic operation updated character information indicating the extent of change in the position and the motion of each relegated character as the game progresses based upon the character information stored at the storage unit of the server apparatus.

The plurality of characters taking part in the game may further include a single server character or a plurality of server characters automatically manipulated under control executed by the server apparatus. The character management program may engage the computer to execute processing for determining, based upon the extent of change in the position of each relegated character having been calculated, a positional relationship among the calculated position of each of relegated characters, the position of one of the server characters managed at the subject server apparatus and the position of the player character managed at a client device and making a decision based upon the positional relationship thus determined that the relegated character is to be managed at the server apparatus in correspondence to the one server character or by the client device, processing for clearing the registration of a relegated character, the management of which has been determined to be delegated to the client device, at the storage unit of the server apparatus and processing for transmitting a character management change packet containing the character information corresponding to the relegated character, the management of which has been determined to be delegated to the client device, to the client device.

The character management program may offer a combat game played by a single player character or a plurality of player characters managed at the single client device or the plurality of client devices and a single computer character or a plurality of computer characters aiding the single or the plurality of player characters, which make up an ally team, and a single server character or a plurality of server characters managed at the server apparatus and a single computer character or a plurality of computer characters aiding the server characters, which make up at least either an enemy team or an ally team.

In this case, even when there are not enough users participating in the game (e.g., even when only a single user is playing the game), any player character and the computer characters attendant to the player character not being played by a participating user are automatically manipulated by the server apparatus. As a result, even if only a few participants are involved in the game, the participating users can fully enjoy the game. In addition, by grouping characters to be managed at each client device separately from the characters to be managed at the server apparatus, the processing in the whole system can be shared so as to allow the game to carry on smoothly.

As explained above, the present invention provides a network game system in which a plurality of characters take part, a client device, a server apparatus and a program used to control the client device and the server apparatus, with which processing and management of the plurality of characters in the game are delegated to multiple devices so as to manipulate the characters smoothly.

### BRIEF DESCRIPTION OF THE DRAWINGS

FIG. 1 shows the overall structure of the network game system adopted in conjunction with various embodiments of the present invention;

FIG. 2 presents an example of a game console that may be used in the various embodiments of the present invention;

FIG. 3 is a hardware block diagram of the game server employed in the various embodiments of the present invention;

FIG. 4 is a hardware block diagram of the game console employed in the various embodiments of the present invention;

FIG. 5 is a functional block diagram of the game server achieved in a first embodiment and a second embodiment of the present invention;

FIG. 6 is a functional block diagram of the game console employed in the various embodiments of the present invention;

FIG. 7 presents an example of character information that may be stored in the RAM in the various embodiments of the present invention;

FIG. 8 presents a flowchart of the client-side management processing routine executed at the game console in the first and second embodiments;

FIG. 9 presents a flowchart of the character management processing routine executed at the game console in the first embodiment;

FIG. 10 presents a flowchart of the character change decision-making processing routine executed at the game console or the game server in the first embodiment and the second embodiment;

FIG. 11 illustrates the state of the game immediately before it shifts to a combat stage;

FIG. 12 presents an example of a positional relationship among a CC and various PCs;

FIG. 13 presents an example of a positional relationship among a CC and various PCs;

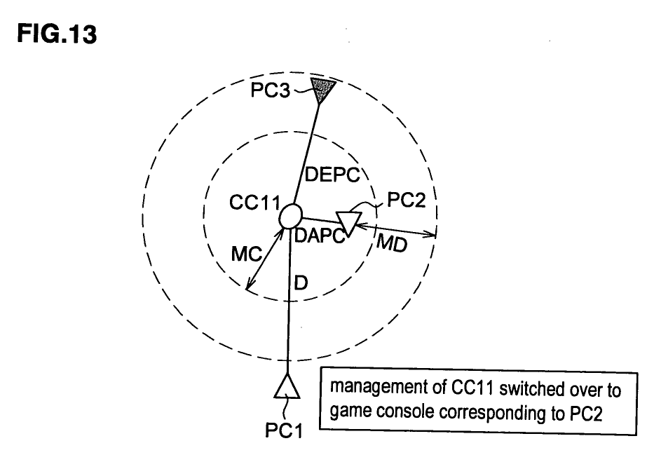

FIG. 14 presents a flowchart of the ally PC management change processing routine executed at the game console or the game server in the first and second embodiments;

FIG. 15 illustrates the game in a combat state;

FIG. 16 presents an example of a positional relationship among a CC and various PCs;

FIG. 17 presents a flowchart of the enemy PC management change processing routine executed at the game console or the game server in the first and second embodiments;

FIG. 18 illustrates a stage in the game during which the subject squad escapes from an enemy squad;

FIG. 19 presents an example of a positional relationship among a CC and various PCs;

FIG. 20 presents an example of a positional relationship among a CC and various PCs;

FIG. 21 presents an example of a positional relationship among a CC and various PCs;

FIG. 22 presents a flowchart of the server-side management processing routine executed by the game server in the first embodiment;

FIG. 23 presents a flowchart of the character management processing routine executed at the game console in the second embodiment;

FIG. 24 presents a flowchart of the server-side management processing routine executed by the game server in the second embodiment;

FIG. 25 is a functional block diagram of the game server achieved in a third embodiment;

FIG. 26 presents a flowchart of the server-side management processing routine executed by the game server in the third embodiment;

FIG. 27 presents a flowchart of the character management processing routine executed at the game console in the third embodiment;

FIG. 28 presents a flowchart of the character change decision-making processing routine executed at the game console or the game server in the third embodiment;

FIG. 29 presents a flowchart of the ally MC management change processing routine executed at the game console or the game server in the third embodiment; and

FIG. 30 presents a flowchart of the enemy MC management change processing routine executed at the game console or the game server in the third embodiment.

### DETAILED DESCRIPTION OF THE PREFERRED EMBODIMENTS

The following is a detailed explanation of the preferred embodiments of the present invention, given in reference to the attached drawings. It is to be noted that in the following explanation and attached drawings, the same reference numerals are assigned to components having structural features and functions identical to one another to preclude the necessity for a repeated explanation thereof.

### First Embodiment

(Overall Structure of Network Game System)

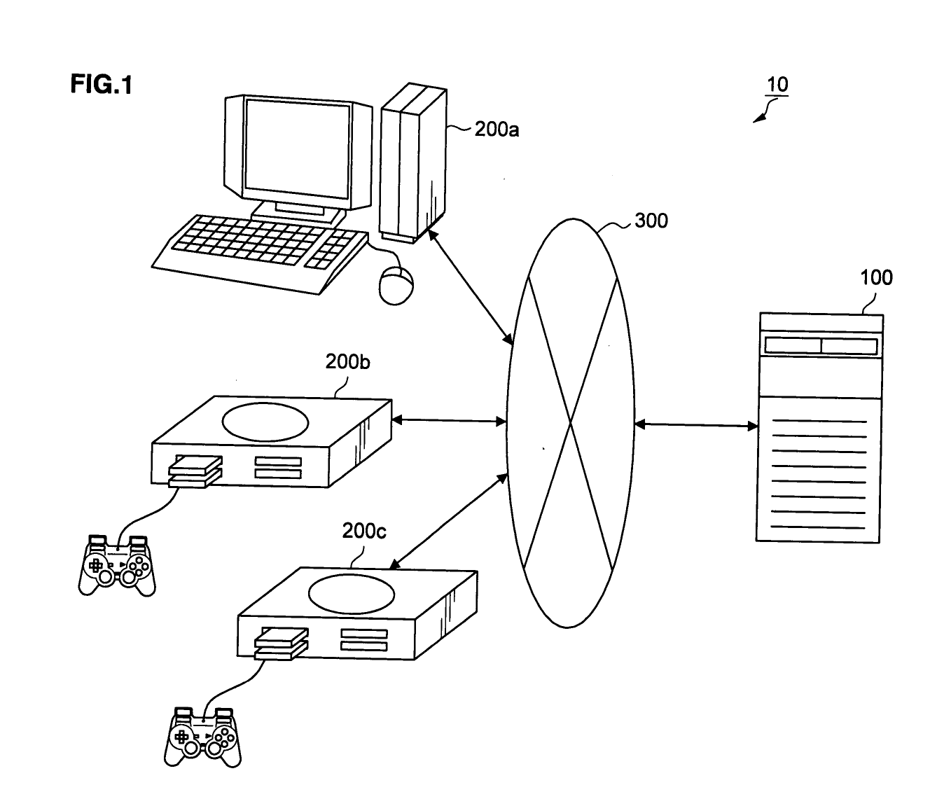

First, the overall structure of the network game system achieved in the first embodiment of the present invention and the primary features of the game executed in the system are explained in reference to FIG. 1.

A network game system 10 is constituted with a network game server (hereafter referred to as a game server) 100 and a plurality of game consoles 200 (200a, 200b and 200c). Since the PC 200a, too, functions as a game console 200 in this network game system, it is regarded as one of the game consoles 200 in the following explanation. The game server 100 and the plurality of game consoles 200 are connected via a network (communication network) 300 such as the Internet.

The game server 100 controls the progress and the management of the network game. More specifically, the game server 100 mainly implements countermeasures against cheating, i.e., it makes a decision as to whether or not a violation has occurred, eliminates the violation and checks the consistency of the transmitted/received data. In addition, the game server 100 receives various types of data from each game console 200 and then transmits the various types of data to the remaining game consoles 200 in batches. The game server 100 also manages item information (specific items held by individual game players), physical fitness information indicating the strength levels of player characters manipulated by the game players and the like stored therein. The game server 100 represents an example of a computer (server apparatus) operated on the network game provider-side, and one of the client devices (game consoles) connected to the network 300 may function as the game server 100.

A game player participates in the network game by operating a game console 200. The game console 200 manages relegated characters to be detailed later among characters taking part in the network game. A given character in the network game is managed at one of the game consoles 200, and a single character is never managed at a plurality of game consoles 200.

In addition, character information with regard to each character managed at a given subject game console 200 is continuously transmitted from the game console 200 to the other game consoles 200 via the game server 100. The character information indicates the state of the character including the character motion. In addition, upon receiving character information transmitted from another game console 200, each game console 200 starts executing motion processing (processing for manipulating the motion of the character in the game). The game console 200 executes collision decision-making (contact decision-making, impact decision-making) with timing matching the timing of the motion.

A game console 200 represents an example of a computer (client device) operating on the side where services provided by the game server 100 are received, and it may be a home game device or a portable game unit. A client device may instead be a user terminal such as a portable device (e.g., a portable telephone, a PDA (personal digital assistant) or the like), instead of a personal computer (PC). It is to be noted that each game console 200 connected to the network 300 in conformance to a specific communication protocol such as TCP/IP is assigned with an IP address different from those assigned to the other game consoles, and thus, each player (console) is able to identify any game console 200 with which various types of data have been exchanged.

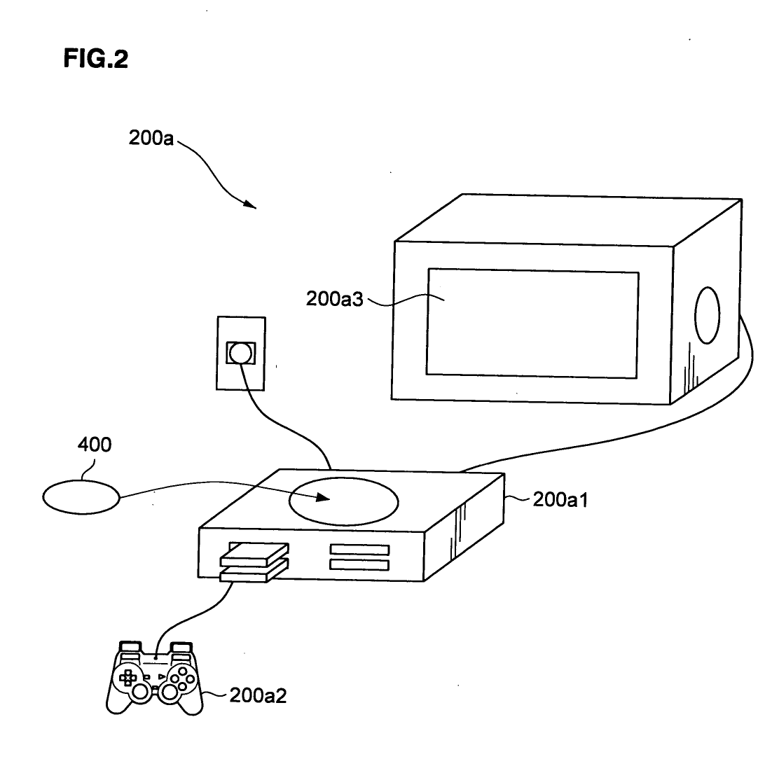

The game console 200 may be constituted with a game console main unit 200a1, a controller pad 200a2 or the like (input device) and a monitor 200a3, as shown in FIG. 2. If the program used in the game console 200a, various types of data including image data and audio data are recorded in a recording medium such as a CD-ROM 400 (or a DVD), the game player (user) loads the recording medium such as the CD-ROM 400 at the game console main unit 200a1 to start the game.

(Primary Features of Network Game System)

The network game system 10 structured as described above offers a network game in which a plurality of characters, including a plurality of player characters each managed at one of the plurality of game consoles 200 and a plurality of computer characters that play supporting roles for the plurality of player characters take part. The game progresses as each game player manipulates his player character via the game console 200 and the plurality of characters take action in response. An explanation is given below in reference to the embodiment on an example in which the network game system 10 offers a combat game in which the plurality of characters including the plurality of player characters and the computer characters aiding the plurality of player characters make up opposing teams and these combat teams fight against one another.

(Team Combat Network Game)

First, the plot line of the game is explained. As a game player manipulates his player character (subject player character) via his game console (subject game console) 200 connected to the network 300, a subject squad made up of the subject player character acting as a squad leader and a plurality of ally computer characters moves on the screen and engages in combat by using weapons in response to game player operations. As another player manipulates an enemy player character via another game console 200 connected to the network 300, an enemy squad with the enemy player character acting as a squad leader moves in the screen and engages in combat by using weapons. Each game player tries to improve the parameters such as the rank and skills of his player character or gain territory controlled by another game player connected via the network 300 by manipulating his player character in combat situations. It is to be noted that the characters taking part in this game include computer characters manipulated by the individual game consoles 200 through automatic arithmetic operations as well as the player characters manipulated by the game players. On the screen, squads each made up with a player character and supporting computer characters are displayed. In the team combat network game achieved in the embodiment, teams, i.e., the subject squad, ally squads and enemy squads, engage in combat via the network 300, as described above.

It is assumed that eight game consoles, divided into opposing teams, each made up of four game consoles, participate in the team combat network game. Four of the eight participating game players may be designated to, for instance, the Tokugawa (a famous feudal lord) team and the remaining four game players may be designated to, for instance, the Toyotomi (Tokugawa's archrival) team. Each team is made up of four squads, and each squad, in turn, is made up with a single player character and up to 79 computer characters. It is to be noted that in the following explanation, the player character manipulated by each game player is simply referred to as a PC (player character), and that among various PCs, the player character manipulated by a subject game player is referred to as the subject PC, ally player characters manipulated other game players are referred to as an ally PCs and enemy player characters manipulated by other game players are referred to as enemy PCs.

In addition, computer characters aiding each of the eight PCs are referred to as CCs (computer characters), and among these CCs, computer characters aiding the subject player character or ally player characters are referred to as ally CCs, whereas computer player characters aiding enemy player characters are referred to as enemy CCs.

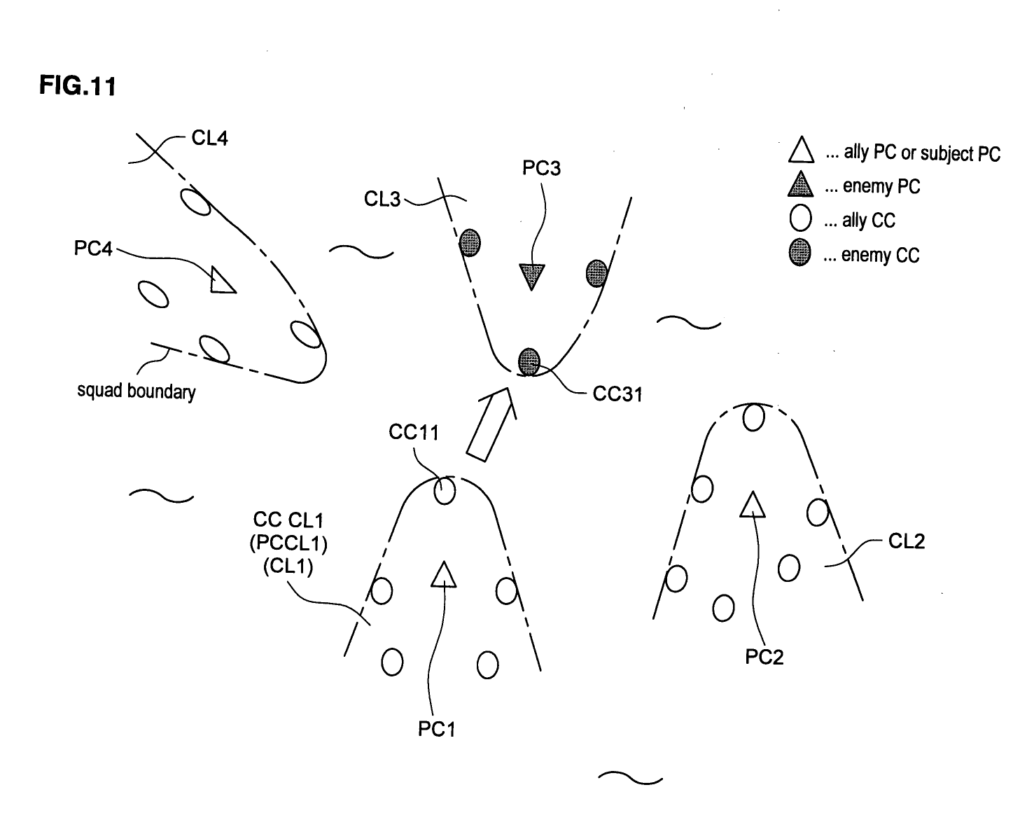

For instance, in FIG. 11, PC1 is the subject PC, PC2 and PC4 are ally PCs and PC3 is an enemy PC. In addition, the CCs (including CC11) present within the squad boundaries around PC1, PC2 and PC4 are ally CCs and CCs (including CC 31) present within the squad boundaries around PC3 are enemy CCs.

(Principle of Computer Character Management)

Next, the principle that applies to the management of the individual characters, i.e., the specific devices to manage the individual characters, is explained. Firstly, the subject PC and CCs belonging to the subject squad among the plurality of squads described above are, in principle, all managed at the subject game console 200. In addition, an ally PC and ally CCs belonging to another squad on the same team are, in principle, managed at the game console 200 through which the ally PC is manipulated. Likewise, and enemy PC and enemy CCs belonging to another squad on the enemy team are managed, in principle, at the game console 200 through which the enemy PC is manipulated. It is to be noted that if a PC needs to be managed at the game server 100 (e.g., if there are not enough game players participating in the game and, accordingly, the game server 100 needs to manage a single or a plurality of enemy PCs or ally PCs), control may be executed so that the CCs belonging to the squad led by the PC to be managed at the game server, too, are automatically managed at the game server 100. This aspect will be explained in detail in reference to the third embodiment. It is assumed in the explanation of the first embodiment and the second embodiment provided below that CCs are each invariably managed at one of the game consoles 200.

It is to be noted that all characters present in the network virtual space are each invariably managed at one of the game consoles 200 in the embodiment. Namely, each game console 200 obtains through arithmetic operation information indicating the positions and the motion (the number assigned to a motion being reproduced, the current frame number) and the like of each of the characters managed at the subject game console over predetermined cycles, draws graphics of the character action based upon the information thus obtained through the arithmetic operation on the display and transmits the data obtained through the arithmetic operation as character information to other game consoles 200 via the game server 100. Upon receiving the character information (to be detailed later) thus transmitted, the other game consoles 200 each draw graphics of the character action on the display based upon the received information data and update the character information stored in their storage areas.

As described above, the network game system 10 achieved in the embodiment is a fully asynchronous game system (which allows the game to progress even if the sets of character information held at the individual game consoles in correspondence to a given frame do not match). If the subject PC manipulated via the subject game console 200 in this network game system attacks a relegated character managed at the subject game console 200, the motion of the relegated character following the attack is calculated at the subject game console 200 and the reaction of the relegated character is immediately reproduced at the subject game console 200 based upon the calculation results. However, if the subject PC manipulated via the subject game console 200 attacks a character managed at another game console 200, the reaction of the attacked character is reproduced at the subject game console 200 after the length of time required for reciprocal communication (subject game console 200->game server 100->other game console 200->game server 100->subject game console 200) elapses.

By taking these characteristics into consideration and switching the game console 200 to manage a given CC in correspondence to the distances between the individual PCs and the CC, the perceptible delays in the motions of the individual characters can be reduced. As a result, the game will have better playability. Based upon this principle, each CC is managed at the game console 200 managing the PC present at the closest position from the coordinates of the CC, regardless of whether the CC is an enemy or an ally. The game server 100 that manages this combat game is explained next, followed by an explanation of how the management of the individual CCs by the game consoles 200 is switched.

(Internal Structures of Game Server and Game Consoles)

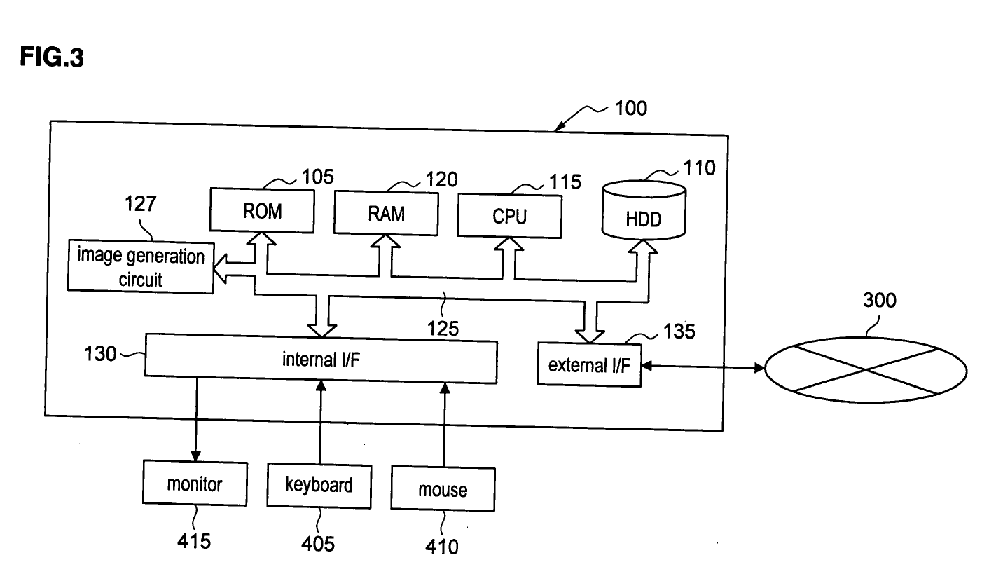

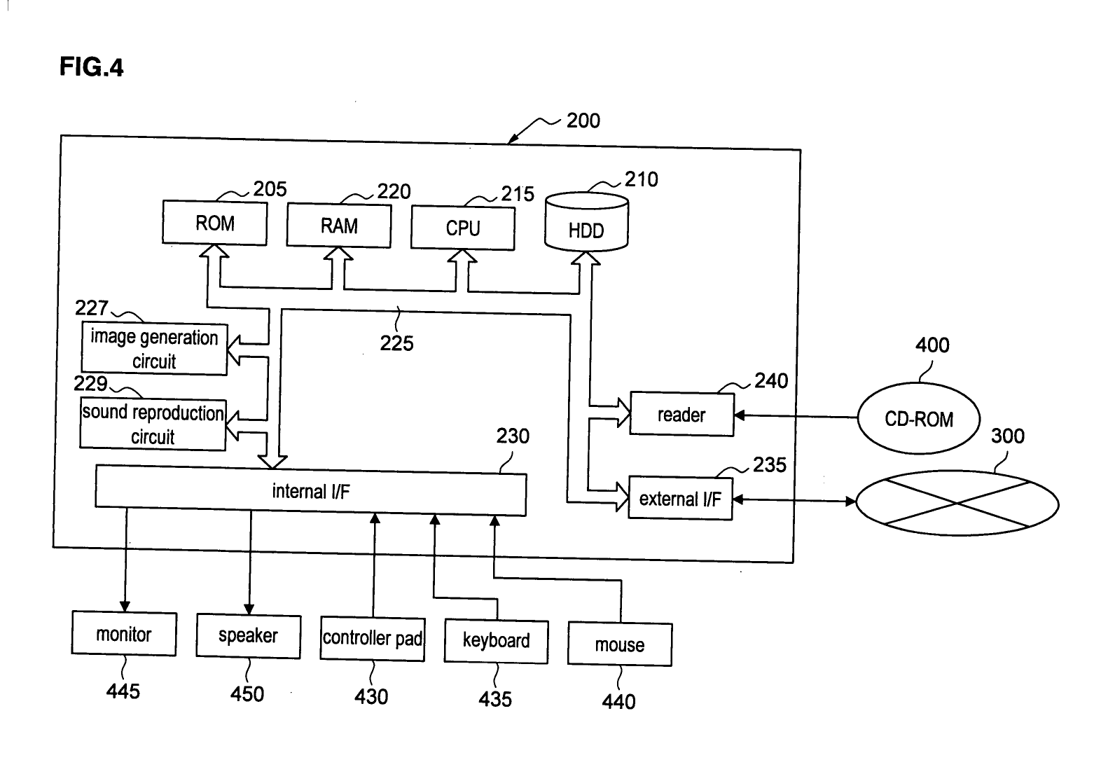

First, the hardware structures of the game server 100 and the game consoles 200 are explained in reference to FIGS. 3 and 4. FIG. 3 shows the hardware structure of the game server 100, whereas FIG. 4 shows the hardware structure of a game console 200.

The game server 100 shown in FIG. 3 includes a ROM 105, a hard disk (HDD) 110, a CPU 115, a RAM 120, a bus 125, an image generation circuit 127, an internal interface (internal I/F) 130 and an external interface (external I/F) 135.

In the ROM 105, a basic program used to operate the game server 100, a program started up when an error has occurred at the game server 100 and the like are recorded. Various programs and data are stored at the hard disk 110. The hard disk 110 represents an example of a storage device and a storage device such as an optical disk or a magneto-optical disk may be used, instead.

The CPU 115 executes the overall control of the game server 100. The CPU 115 loads the program stored in the hard disk 110 or the like into the RAM 120, to be used as a work area, and executes the loaded program. The bus 125 constitutes a path through which information is exchanged among various devices including the ROM 105, the hard disk 110, the CPU 115, the RAM 120, the image generation circuit 127, the internal interface 130 and the external interface 135.

The image generation circuit 127, constituted with a graphics chip and a VRAM, generates an image in a time sequence different from the time sequence at the CPU 115 in response to an image generation instruction issued by the CPU 115.

Data related to the network game are input to the internal interface 130 via a keyboard 405 or a mouse 410, and necessary data are output from the internal interface 130 to a monitor 415. The external interface 135 is used to exchange various types of data with other game consoles 200 participating in the game via the network 300.

The game console 200 in FIG. 4 includes a ROM 205, a hard disk (HDD) 210, a CPU 215, a RAM 220, a bus 225, an image generation circuit 227, a sound reproduction circuit 229, an internal interface 230, an external interface 235 and a reader 240.

A program and the like used to operate the game are recorded in the ROM 205. Various programs and various types of data are stored at the hard disk 210. The hard disk 210 represents an example of a storage device and a storage device such as an optical disk or a magneto-optical disk may be used, instead.

The CPU 215 executes the overall control of the game console 200. The CPU 215 loads the program stored in the hard disk 210 into the RAM 220 used as a work area within the game console 200. The CPU 215 may instead load the program in a CD-ROM 400 read by the reader 240 into the RAM 220. The CPU 215 executes the program thus loaded into the RAM 220 to start the game and advance the game by engaging in communication with the game server 100 as necessary.

It is to be noted that once the CPU 215 copies the program and the like on the recording medium into the RAM 220, the game can be started next time by simply executing the program in the RAM 220. In addition, once the CPU 215 copies the program and the like in the CD-ROM 400 into the hard disk 210 within the game console 200, the game can be started next time simply by executing the program in the hard disk 210. If, on the other hand, the program and the like are uploaded on the network 300, the CPU 215 may first download the program and the like into the RAM 220 in the game console 200 and then start the program. Alternatively, the CPU 215 may first download the program and the like into the hard disk 210 of the game console 200 and may start the game next time simply by starting up the program stored in the hard disk 210.

The bus 225 constitutes a path through which information is exchanged among various devices including the ROM 205, the hard disk 210, the CPU 215, the RAM 220, the image generation circuit 227, the sound reproduction circuit 229, the internal interface 230, the external interface 235 and the reader 240.

The image generation circuit 227, constituted with a graphics chip and a VRAM, generates an image in response to an image generation instruction issued by the CPU 215. The sound reproduction circuit 229, constituted with a sound chip and a sound RAM, executes sound processing to generate background music, combat sounds and the like corresponding to the combat motions of the individual relegated characters in response to a sound generation instruction issued by the CPU 215.

Game operations performed by the game player are input to the internal interface 230 via a controller pad 430, a keyboard 435 or a mouse 440, and images and sound effects corresponding to a plurality of characters engaged in combat with one another on opponent teams are output from the internal interface 230 to a monitor 445 and a speaker 450. The external interface 235 is used to exchange various types of data including commands corresponding to game player operations and messages with the game server 100 via the network 300. The reader 240 reads data from the CD-ROM 400.

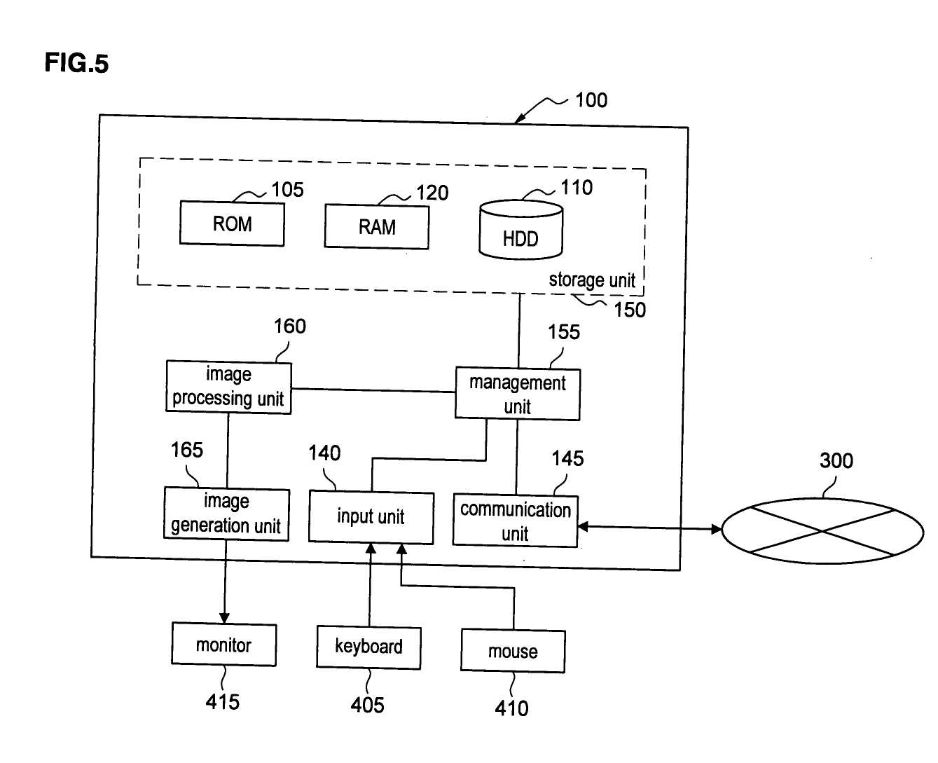

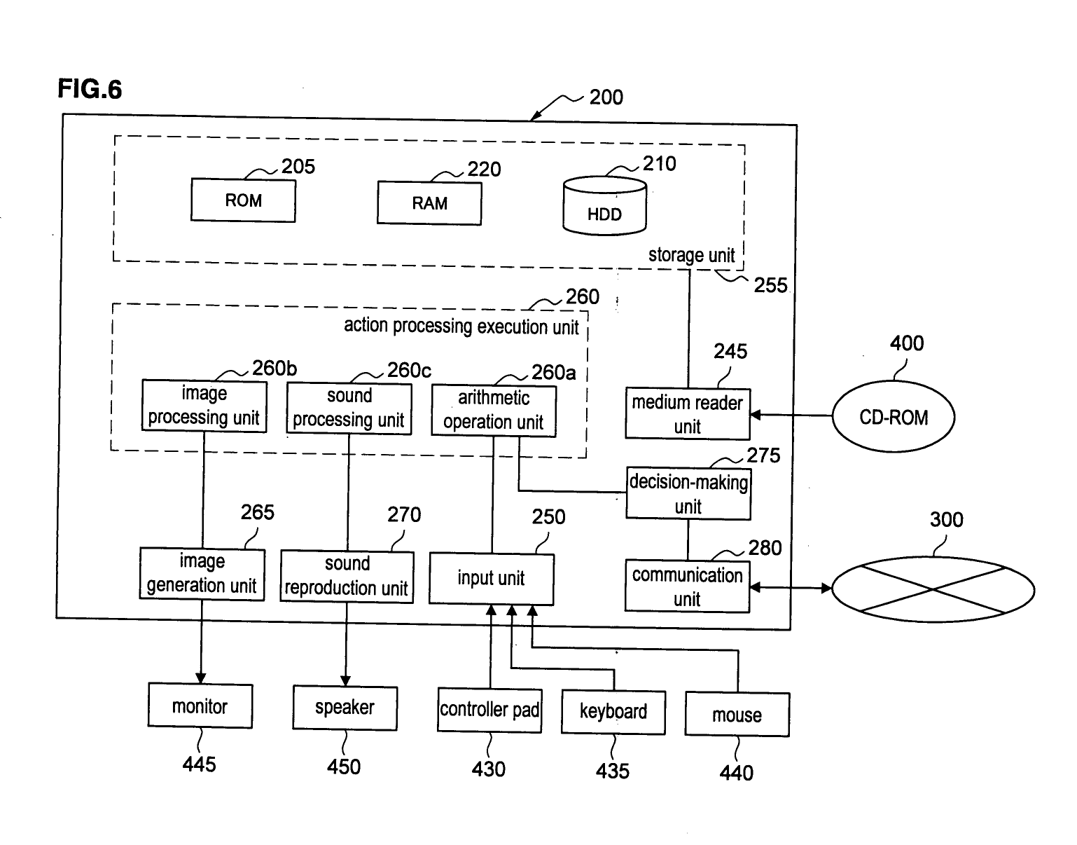

Next, the functional structures adopted in the game server 100 and the game console 200 are explained in reference to FIGS. 5 and 6.

(Functional Structure of Game Server)

As shown in FIG. 5, the game server 100 has functions represented by function blocks that include an input unit 140, a communication unit 145, a storage unit 150, a management unit 155, an image processing unit 160 and an image generation unit 165.

Data are input via the input unit 140 in response to an operation performed by the custodian of the network game at the keyboard 405 or the mouse 410. The communication unit 145 exchanges necessary information with the plurality of game consoles 200 participating in the game.

The storage unit 150 stores character information including position information indicating the positions of the plurality of characters (the player characters (PCs) and computer characters (CCs)) and identification information used to identify the game consoles 200 managing the individual computer characters CCs.

The management unit 155 manages the data input via the input unit 140, the data exchanged through the communication unit 145 and the data stored in the various storage areas (the ROM 105, the RAM 120 and the hard disk 110) of the storage unit 150 and also manages the timing with which various types of processing are executed during the game, so as to allow the game to progress without discrepancy by maintaining the consistency of the data used in the game.

The image processing unit 160 issues an instruction for the image generation unit 165 for image generation by generating a parameter and a command whenever they become needed as the game progresses and outputting the parameter and the command to the image generation unit 165. Upon receiving the image generation instruction from the image processing unit 160, the image generation unit 165 executes light source processing and the like and draws combat motions of the individual relegated characters at the monitor 445 in a three-dimensional field based upon the character information.

(Functional Structure of Game Consoles)

As shown in FIG. 6, the game consoles 200 each have functions represented by functional blocks that include a medium reader unit 245, an input unit 250, a storage unit 255, an action processing execution unit 260, an image generation unit 265, a sound reproduction unit 270, a decision-making unit 275 and a communication unit 280.

The medium reader unit 245 reads data stored in the recording medium such as the CD-ROM 400. For instance, as the game player inserts the CD-ROM 400 at his game console 200 and starts the game, the medium reader unit 245 automatically reads the data such as the program and transfers the data thus read to the RAM 220.

As the game player, viewing the screen of the network game displayed at the monitor 445, operates an input device such as the game controller pad 430, the keyboard 435 or the mouse 440 connected to the game console 200, data corresponding to the game player operation are input via the input unit 250.

The storage unit 255 stores the character information including the position information indicating the positions of the plurality of characters in the RAM 220 and also registers characters managed at the subject game console 200 among all the computer characters as relegated characters at the RAM 220.

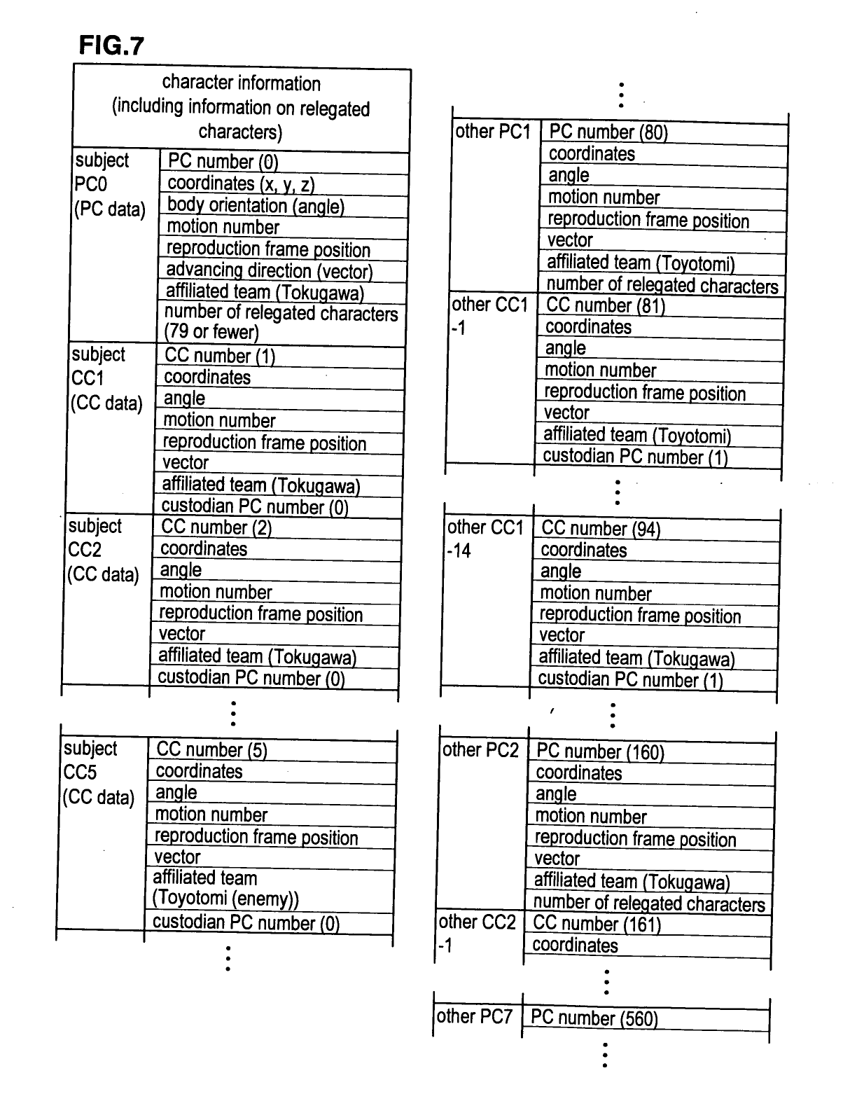

In reference to FIG. 7, the various types of information stored in the RAM 220 are explained. FIG. 7 presents an example of a data structure that may be adopted with regard to the character information stored in the RAM 220.

In the RAM 220, PC data corresponding to the subject player character (subject PC0) managed at the subject game console 200 among all the player characters are stored. The character information corresponding to the subject PC0 held in the RAM 220 indicates the PC number, the coordinates (x, y, z), the orientation (angle) of the character's body, the motion number, the reproduction frame position, the advancing direction, the team affiliation and the number of currently relegated characters.

As the PC number, the identification number of the game console (CL, client device) managing the subject PC0 is assigned. While “0” is registered as the PC number in this example, a number other than “0” may be registered as long as it enables identification of the game console managing the PC.

The coordinates (x, y, z) indicate the position of the character in the virtual space. The motion number indicates the number assigned to motion data created in advance to indicate a specific motion of the character. Each set of motion data is assigned with an inherent motion number, and the data are recorded in the recording medium such as the hard disk 210 at each game console 200.

The motion of the character is graphically drawn in correspondence to each frame (the time unit for the image processing) and, accordingly, the reproduction frame position indicates the position of the frame for which the motion indicated by the motion number should be reproduced. The advancing direction indicates the vector of the direction along which the character advances. The team affiliation indicates is the team to which the subject PC0 belongs. While the subject PC0 currently belongs to the “Tokugawa” team, it may switch its affiliation to the opponent team. The number of currently relegated characters indicates the number of relegated characters (computer characters CCs) currently managed at the subject game console 200 and assumes a numerical value equal to or smaller than 79.

The character information corresponding to the 79 subject computer characters (subject CC1 through subject CC79) aiding the subject player character (subject PC0) is also stored in the RAM 220. The character information for a computer character (CC) differs from the character information for a player character (PC) in that while the character information for the player character (PC) includes “the number of currently relegated characters” as the last data item, the character information for the computer character (CC) includes “the custodian PC number” as the last data item. For instance, the custodian PC number corresponding to the subject computer character 1 (subject CC1) is “0”. This indicates that the subject CC1 is registered at the RAM 220 as a relegated character managed at the subject PC0.

The character information corresponding to the other seven player characters (other PCs 1 through 7) is also stored in the RAM 220. In addition, the character information corresponding to other computer characters (other CCs 1-1 through 1-79, other CCs 2-1 through 2-79, other CCs 3-1 through 3-79, other CCs 4-1 through 4-79, other CCs 5-1 through 5-79, other CCs 6-1 through 6-79 and other CCs 7-1 through 7-79) aiding the other player characters is stored in the RAM 220. Thus, the character information for all the characters (640 characters) taking part in the game is stored in the RAM 220 and, based upon the character information, the action to be taken next by each character taking part in the combat game is calculated through arithmetic operation and a decision as to which characters should be managed at the subject game console 200 is made.

An explanation is now given in reference to FIG. 6 again. The action processing execution unit 260 includes an arithmetic operation unit 260a, an image processing unit 260b and a sound processing unit 260c. The action processing execution unit 260 executes action processing for each of the relegated characters registered at the storage unit 255. More specifically, based upon the character information stored at the storage unit 255, the arithmetic operation unit 260a calculates through arithmetic operation change quantities indicating the extent of change in the position and the extent of change in the motion of each relegated character resulting from a combat action in the game and thus generates updated character information.

The image processing unit 260b issues an instruction for the image generation unit 265 for image generation by generating a parameter and a command whenever they become needed as the game progresses and outputting the parameter and the command to the image generation unit 265. Upon receiving the image generation instruction issued by the image processing unit 260b, the image generation unit 265 generates an image and displays the generated image at the monitor 445.

The sound processing unit 260c issues a sound reproduction command for the sound reproduction unit 270. The sound reproduction unit 270 executes sound processing to generate background music and combat sound effects corresponding to the combat action of each relegated character and outputs the sound thus generated to the speaker 450. The realistic images and sound effects thus provided enhance the enjoyment of the game playing as each game player manipulates his player character to travel and engage in combat against another character within the virtual space of the network game.

Based upon the change quantity indicating the extent of change in the position of each relegated character calculated by the arithmetic operation unit 260a, the decision-making unit 275 determines the positional relationship among the position of the player character managed at the subject game console 200, the position of a player character managed at another game console 200 and the position of the relegated character having undergone the action processing and makes a decision as to whether or not the relegated character should continue to be managed at the subject game console based upon the positional relationship thus determined.

The communication unit 280 transmits the updated character information corresponding to each relegated character, having been obtained through the arithmetic operation executed by the arithmetic operation unit 260a, to the game server 100 as a character information packet. In addition, the communication unit 280 transmits the character information corresponding to a relegated character with regard to which the management is determined to be switched to another game console 200, to the game server 100 as a character management change packet. It is to be noted that although their contents may be identical, the data held in memory such as the RAM 220 are referred to as “˜information” and the data exchanged through transmission/reception operations are referred to as “˜packet” in the description and the drawings.

Furthermore, the communication unit 280 receives a character information packet transmitted from the game server 100. Namely, various types of data including information indicating the results of a change having occurred in the network game, information transmitted from another game player and transferred via the game server 100 and information made available and transmitted by the game server 100 are received at the communication unit 280.

As the action processing execution unit 260 executes the action processing for each of the relegated characters based upon the character information received at the communication unit 280 or character information obtained through arithmetic operation executed by the arithmetic operation unit 260a, the network game progresses with the game console 200 and the game server 100 engaged in communication with each other as necessary.

It is to be noted that the various functions of the game server 100 and the game consoles 200 explained above are achieved in reality as the CPUs execute the program in which the processing procedure for enabling these functions is written, as the hardware and/or the IC are used to realize these functions. For instance, the functions of the management unit 155 and the image processing unit 160 at the game server 100 shown in FIG. 5 may be realized by the CPU 115 in FIG. 3 as it executes the processing program for realizing these functions, and the function of the image generation unit 165 may be realized at the graphic chip (image generation circuit 127). In addition, the functions of the action processing execution unit 260 and the decision-making unit 275 at the game console 200 shown in FIG. 6 may be realized by the CPU 215 in FIG. 4 as it executes the processing program for realizing these functions and the functions of the image generation unit 265 and the sound reproduction unit 270 may be respectively realized at the graphic chip (image generation circuit 227) and the sound chip (sound reproduction circuit 229).

In the network game system 10 achieved in the embodiment described above, each game player first selects a player character to be manipulated via the subject game console 200. For instance, if the game is set in the feudal era, the game player will normally select a character such as a samurai, a ninja or an onmyo-ji (sorcerer). Subsequently, the game player manipulates his player character in combat scenes to raise parameters such as the rank, the skills and the like of the player character or to fight against characters affiliated with another game player operating another game console 200 connected via the network 300. It is to be noted that the characters taking part in the game played in this virtual space include computer characters (CCs) manipulated based upon the results of automatic arithmetic operations executed at the individual game consoles 200 as well as the player characters manipulated by game players, and these characters are all displayed at the screens at the game consoles 200.

(Operations at Game Consoles; Action Processing and Character Management Processing)

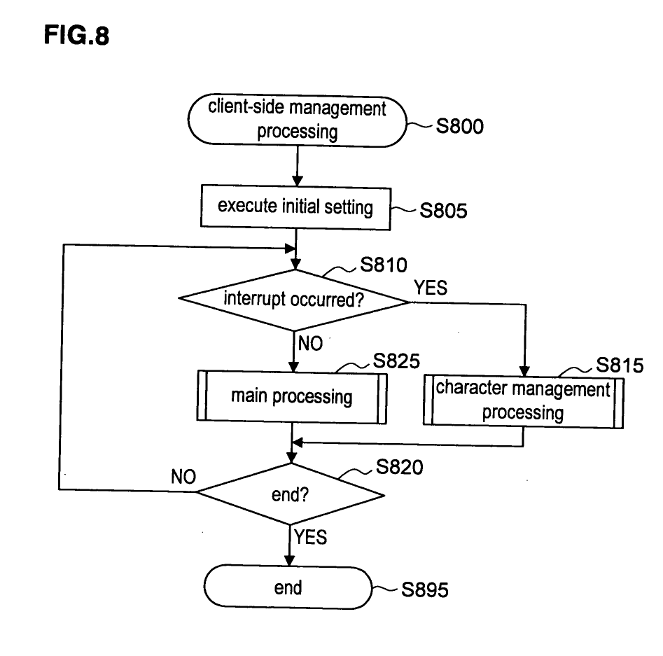

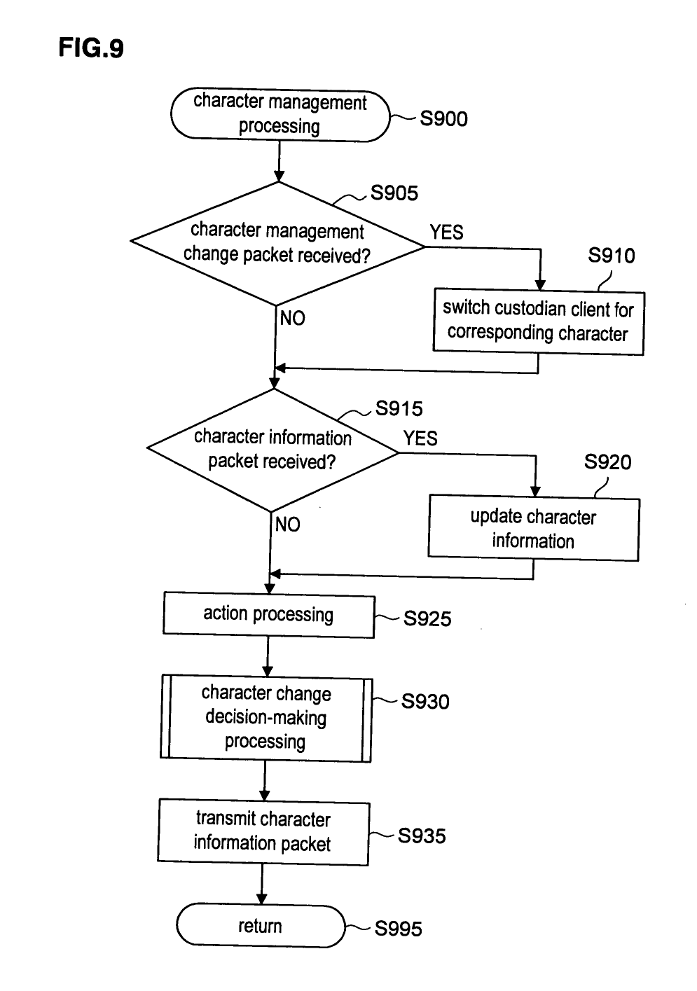

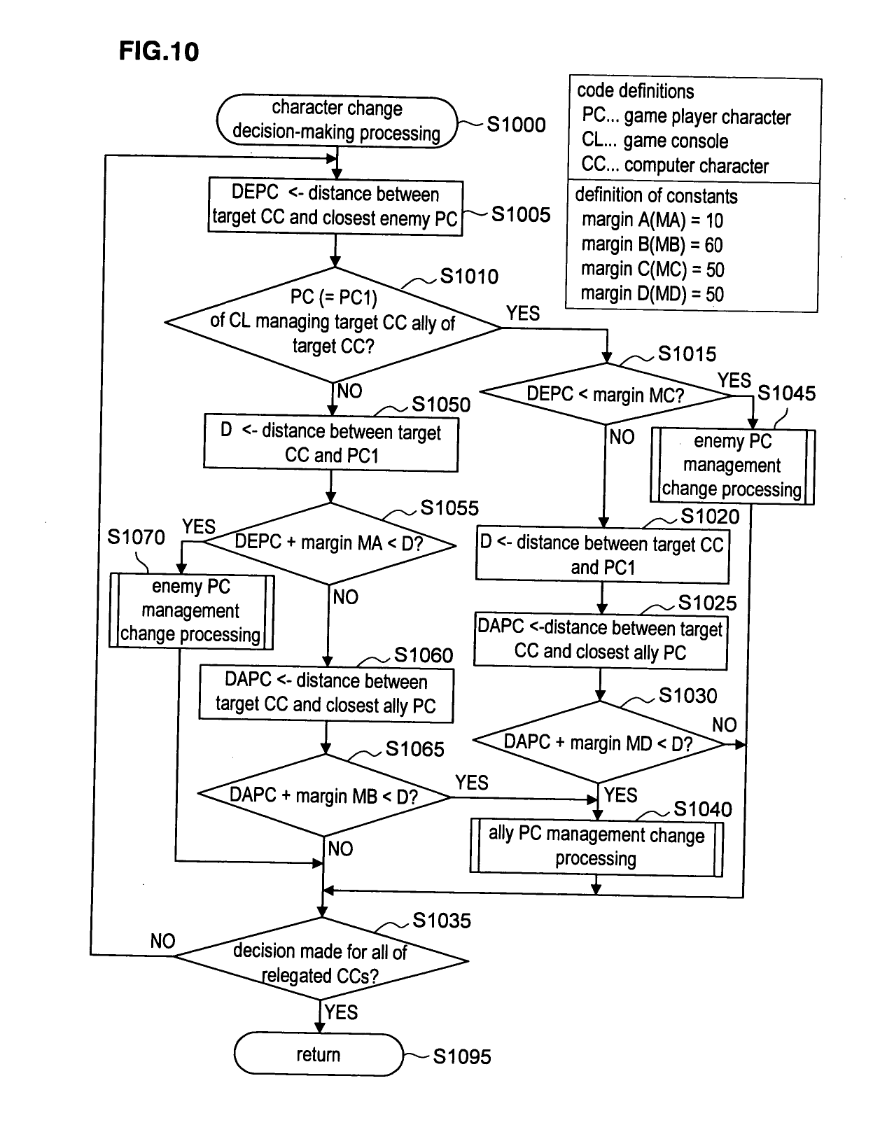

Next, the operations executed at each game console 200, and more specifically, the action processing and the character management processing characterizing the embodiment, are explained in detail in reference to FIGS. 8 through 10. FIG. 8 presents a flowchart of the client-side management processing (main routine) executed at each game console 200. FIG. 9 presents a flowchart of the character management processing called up from the main routine in FIG. 8. FIG. 10 presents a flowchart of the character change decision-making processing called up from the subroutine in FIG. 9. It is to be noted that since the processing executed with regard to the actions of the squad belonging to the subject game player and the processing executed with regard to the actions of squads belonging to other game players are basically identical to each other, an explanation is given in reference to the flowcharts by simply focusing on the processing for the squad belonging to the subject game player without providing a detailed description of the processing for the squads belonging to the other game players. In addition, an explanation of other specific processing that needs to be executed for the game to progress but does not bear direct relevance to the embodiment of the present invention is not provided.

Before participating in the network game, each game player needs to complete the user registration. Namely, the game player transmits personal information and the like to the game server 100 by entering the personal information in response to instructions displayed at the screen of the game console 200 and obtains a user ID and a user password. Subsequently, the player is able to access the game server 100 simply by entering the user ID and the password thus obtained at the screen to participate in the game again.

(Game Start)

As the power to the game console 200 is turned on and the game player issues a game start request, the processing starts in step 800 in FIG. 8. In step 805, an initial setting operation is executed. In more specific terms, the storage unit 255 preregisters the character information corresponding to the player character (subject PC) selected by the game player and the individual characters at the RAM 220. In addition, the communication unit 280 verifies the user and subsequently, exchanges character information for the individual characters with the game server 100. As a result, the character information corresponding to the various characters shown in FIG. 7 is preregistered at the RAMs of the game server 100 and all the other game consoles 200 participating in the game. In addition, the game server 100 identifies the game consoles 200 managing the various characters in correspondence to each of the characters, and information indicating the custodian game consoles is stored in the RAMs at the game server 100 and the individual game consoles 200 (the information entered as the custodian PC numbers in FIG. 7). It is to be noted that the character information corresponding to the individual characters does not need to be stored at the game server 100.

Next, in step 810, the decision-making unit 275 makes a decision as to whether or not an interrupt (a vertical trace line interrupt (Vsync)) has occurred. The decision-making unit 275 makes an affirmative decision (“YES”) in step 810 as an interrupt occurs at the rate of once every 1/60 sec (16.6 milliseconds) matching the length of the vertical trace line cycles at the monitor 445, and in this case, the operation proceeds to step 815 to execute character management processing. The character management processing is to be explained in detail later.

Next, the operation proceeds to step 820 in which the decision-making unit 275 makes a decision as to whether or not the game is to end. More specifically, the game ends if the game player turns off the power to the game console 200 or selects “game end” on the screen. Until the game player performs either of these operations, the game console 200 basically executes the processing in steps 810 through 820 repeatedly, and once the player performs either of the operations, the operation proceeds to step 895 to end the game.

If an interrupt has not occurred, the decision-making unit 275 makes a negative decision (“NO”) in step 810, and in this case, the operation proceeds to step 825 to execute main processing. Once the main processing is executed, the operation proceeds to step 820. It is assumed that processing other than the processing bearing direct relevance to the network game in the embodiment, such as processing for constantly updating as necessary input information by storing into the RAM 220 information input by the game player as he operates the controller pad 430 or the like and taken in via the input unit 250 and sound processing for synthesizing game sound effects by engaging the sound processing unit 260c and the sound reproduction unit 270, is also executed during the main processing. In addition, while the client-side management processing is executed over specific time intervals (i.e., the character management processing is executed as part of the interrupt processing executed over intervals matching the vertical trace line cycles) in the embodiment, the character management processing may instead be executed as part of timer interrupt processing (not shown) or as part of the main processing executed in step 825.

(Character Management Processing)

Next, the character management processing executed in step 815 is explained in reference to the flowchart presented in FIG. 9. After the processing starts in step 900, the communication unit 280 makes a decision in step 905 as to whether or not a character management change packet transmitted from another game console 200 has been received. If a character management change packet has been received, the operation proceeds to step 910 in which the corresponding character information in the RAM 220 is updated at the storage unit 255 based upon the character information contained in the received character management change packet. More specifically, the information indicating the coordinates, the body orientation, the motion number, the reproduction frame position, the advancing direction and the team affiliation, which is stored as the character information for the corresponding PC or the corresponding CC in FIG. 7, is updated. In addition, the storage unit 255 registers the character identified in correspondence to the character information as a relegated character. More specifically, the custodian PC number in the corresponding character information in FIG. 7 is altered.

Next, the operation proceeds to step 915 in which the communication unit 280 makes a decision as to whether or not a character information packet has been received from another game console 200. If a character information packet has been received, the operation proceeds to step 920 in which the corresponding character information in the RAM 220 is updated at the storage unit 255 based upon the character information contained in the received character information packet. More specifically, the information indicating the coordinates, the body orientation, the motion number, the reproduction frame position, the advancing direction and the team affiliation, which is stored as the character information for the corresponding PC or the corresponding CC in FIG. 7 is updated. It is to be noted that the term “frame” is used to refer to a drawing frame representing the time unit of the image processing. The length of time corresponding to each frame is equal to ½ of the length of the vertical trace line interrupt processing cycles in the present embodiment.

Then, the operation proceeds to step 925 in which the action processing execution unit 260 executes the action processing. The action processing specifically refers to the processing described below, which is executed at the individual units constituting the action processing execution unit 260. First, the arithmetic operation unit 260a obtains through arithmetic operation character information indicating change quantities that represent the extents of changes in the position and the motion of each relegated character resulting from a game player operation based upon the character information stored in the RAM 220 (i.e. the correlation of the character information corresponding to the relegated characters managed at the subject game console and the character information corresponding to the relegated characters managed at other game consoles relative to one another). The arithmetic operation executed for each relegated character makes it possible to manipulate the character so that it takes appropriate action such as shifting to a reaction when it has been struck by an attacker.

In addition, the image processing unit 260b issues an image generation instruction to the image generation unit 265 and in response to the instruction, the image generation unit 265 executes graphic processing to create an image of the motion of each character at a specific position in the virtual space based upon the character information resulting from the arithmetic calculation. The sound processing unit 260c issues a sound generation instruction to the sound reproduction unit 270, and in response to the sound generation instruction, the sound reproduction unit 270 generates a sound effect matching the state of each character based upon the character information resulting from the arithmetic operation. Thus, character motions reflecting the operations of the individual game players are displayed at the monitor 445 and also, sound effects matching the state of the game in progress are output through the speaker 450, as the game is played out in response to the operations performed by the individual game players.

Next, the operation proceeds to step 930, in which the decision-making unit 275 executes character change decision-making processing (a subroutine). This processing, through which a decision is made with regard to the game console 200 best suited to manage each relegated character based upon the positional relationship between the position of the relegated character and the positions of enemy PCs, ally PCs and the subject PC, is to be described in detail later.

Then, the operation proceeds to step 935 in which the communication unit 280 transmits the character information for each of the relegated characters having been obtained through the arithmetic operation executed by the arithmetic operation unit 260a to the other game consoles 200 via the game server 100. As the information indicating the latest character states is transmitted to the other game consoles 200, as described above, the character information for those characters stored in the other game consoles 200 is updated, albeit with a delay necessitated by the length of time required for the communication. As a result, the data consistency is maintained.

(Character Change Decision-Making Processing)

Next, the character change decision-making processing executed in step 930 is explained in detail in reference to FIG. 10.

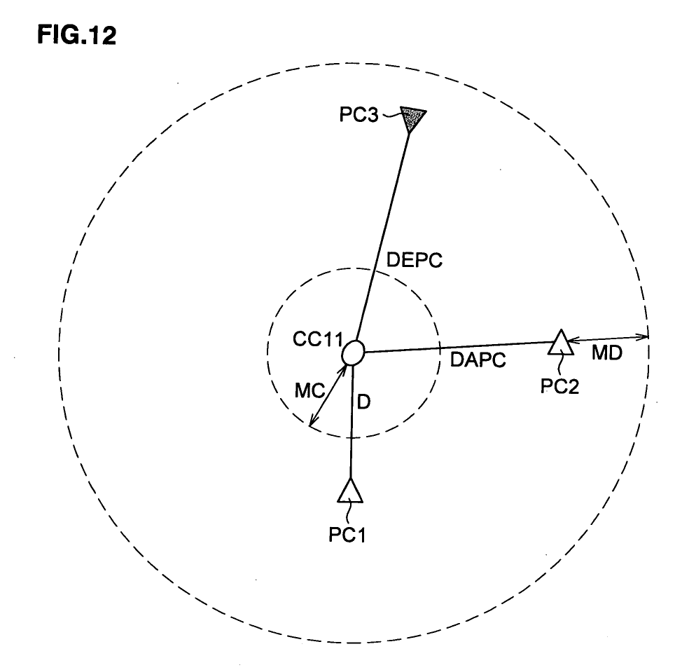

After the character change decision-making processing starts in step 1000, the operation proceeds to step 1005, in which the arithmetic operation unit 260a determines the distance DEPC between the CC registered as a relegated character and the enemy PC present at the position closest to the CC (the distance between the coordinates of the target CC in FIG. 7 and the coordinates of the closest enemy PC in FIG. 7). For instance, if the squad belonging to the subject PC1 is moving toward the squad led by the enemy PC3 in order to attack the squad belonging to the enemy PC3, as shown in FIG. 11, the distance DEPC between the target CC (CC11) and the enemy PC3 is calculated as shown in FIG. 12.

Then, the operation proceeds to step 1010 in which the decision-making unit 275 makes a decision as to whether or not the PC (i.e., the subject PC1) played by the game player operating the game console 200 (the subject game console at this point) that manages the CC11 is fighting on the side of the CC11. Since the subject PC1 is fighting on the same side as the CC11 at this point in time, the decision-making unit 275 makes an affirmative decision and in the operation proceeds to step 1015. In step 1015, the decision-making unit 275 makes a decision as to whether or not the distance DEPC is smaller than a margin MC (=50). At this point, the PC3 is still outside the circle around the CC11 with a radius matching the margin MC, and thus, the distance DEPC is greater than the margin MC. Accordingly, the operation proceeds to step 1020 in which the arithmetic operation unit 260a determines the distance D between the CC11 and the subject PC1, and then, the operation proceeds to step 1025 to determine the distance DAPC between the CC11 and the closest ally PC (=PC2).

Then, the operation proceeds to step 1030 in which the decision-making unit 275 makes a decision as to whether or not the value obtained by adding a margin MD (=50) to the distance DAPC is smaller than the distance D. At this point in time, the sum of the distance DAPC and the margin MD is greater than the distance D. In other words, the PC2 is still outside the circle around the CC11 with a radius matching the difference between the distance D and the margin MD. Accordingly, the decision-making unit 275 makes a negative decision and the operation proceeds to step 1035 (without switching the management of the CC11 to another user console 200). In step 1035, a decision is made as to whether or not the character change decision-making processing has been executed for all the relegated CCs currently in managed at the subject console (i.e., for all the relegated characters). Until it is decided in step 1035 that all the relegated characters have undergone the character change decision-making processing, the operation returns to step 1005 to continuously execute the change decision-making processing for the individual relegated characters, and once the change decision-making processing is completed, the processing ends in step 1095.

Next, an explanation is given to the character change decision-making processing executed when the squad led by PC2 in FIG. 11 alone has moved close to the squad belonging to PC1. In this situation, the distance between the ally PC2 and the CC11 is smaller than the distance between CC11 and the subject PC1 by an extent equal to or greater than the margin MD and, accordingly, the decision-making unit 275 makes an affirmative decision (“YES”) in step 1030 following steps 1000 through 1025. Subsequently, the operation proceeds to step 1040 to execute ally PC management change processing.

(Ally PC Management Change Processing)

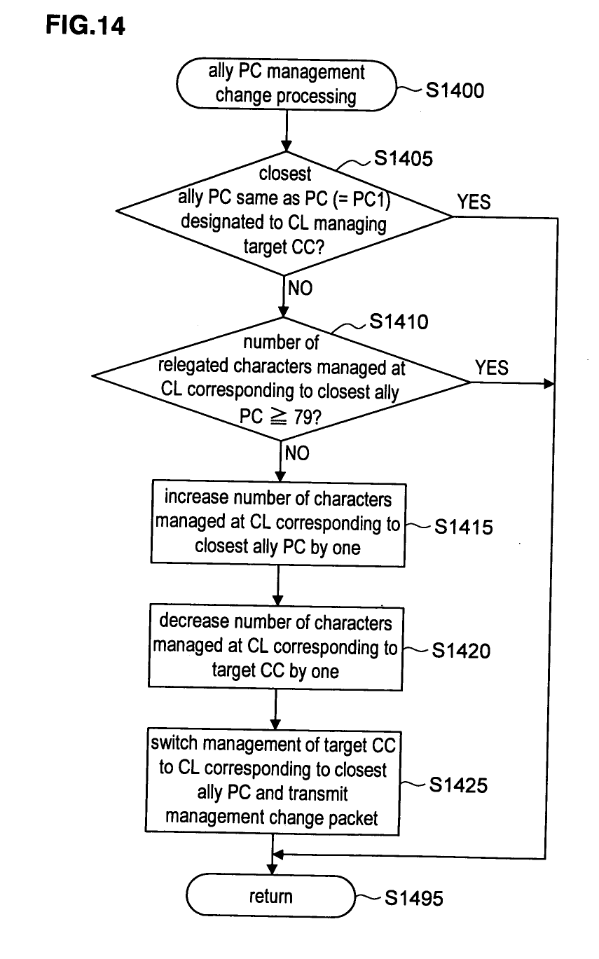

More specifically, as shown in FIG. 14 after the ally PC management change processing starts in step 1400, the operation proceeds to step 1405 in which the decision-making unit 275 makes a decision as to whether or not the closest ally PC (=PC2) is the PC (=PC1) manipulated through the game console 200 (CL) currently managing the target CC (=CC11). Since these player characters are not the same character, the decision-making unit 275 makes a negative decision in step 1405 and the operation proceeds to step 1410. In step 1410, the decision-making unit 275 makes a decision as to whether or not the game console corresponding to the closest ally PC (=PC2) is currently managing 79 or more relegated characters. If the number of relegated characters managed at the game console that manages the PC2 is smaller than 79, the operation proceeds to step 1415 in which the number of relegated characters indicated in the character information corresponding to the PC2 stored in the RAM 220 is increased by one at the storage unit 255. Then the operation proceeds to step 1420, in which the number of relegated characters managed at the game console (CL) that manages the PC (=PC1) and also currently manages the target CC (=CC11) is decreased by one.

Subsequently, the operation proceeds to step 1425 in which the communication unit 280 transmits a management change packet containing information indicating a switch-over of the management of the target CC (=CC11) from the game console 200 that manages the PC1 to the game console 200 that manages the PC2 to the other game consoles 200 via the game server 100 and then the operation proceeds to step 1495 to end the processing. As described above, if the ally PC2 is present at a position closer to the CC11 than the subject PC1 by an extent equal to or greater than the margin MD, the management of the relegated character (CC11) is switched over to the game console that manages the ally PC2.

It is to be noted that if it is decided in step 1405 that the closest ally PC is the PC manipulated through the game console 200 currently managing the subject CC, the management of the relegated character does not need to be switched. In addition, if it is decided in step 1410 that the number of relegated characters currently managed at the game console 200 corresponding to the closest ally PC is equal to or greater than 79, the number of relegated characters managed at the particular game console should not increase any further. Accordingly, the management of the relegated character is not switched. In either case, the operation proceeds to step 1495 to end the processing.

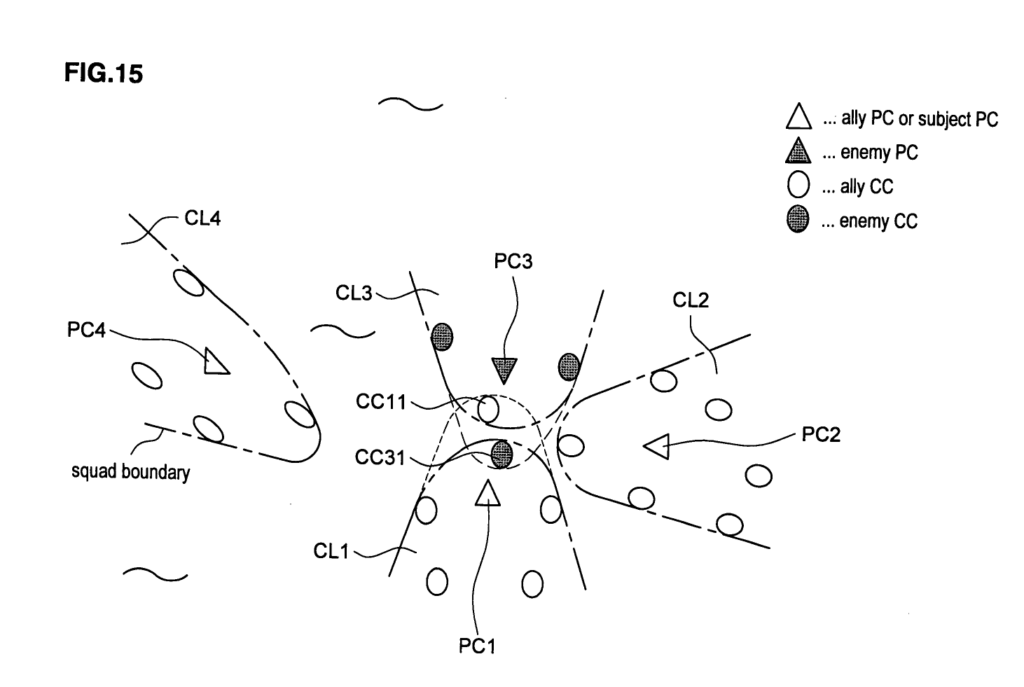

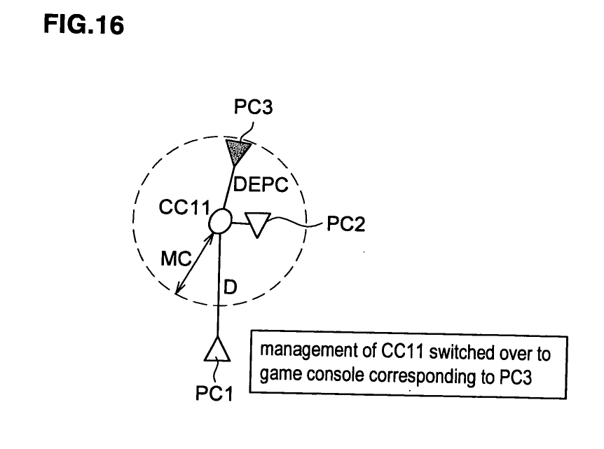

Next, an explanation is given to the character change decision-making processing executed when the game has progressed from the state shown in FIG. 11 to the state shown in FIG. 15 (i.e., when the squad belonging to the subject PC1, the squad belonging to the enemy PC3 and the squad belonging to the ally PC2 are all engaged in team combat). In this case, the enemy PC3, too, is present within the circle around the CC11 with a radius matching the margin MC, although the CC11 is at the closest position to the ally PC2, as shown in FIG. 16. In this situation, after the character change decision-making processing starts in step 1000 in FIG. 10, the decision-making unit 275 makes an affirmative decision (“YES”) in step 1015 following steps 1005 and 1010, and then the operation proceeds to step 1045 to execute enemy PC management change processing.

(Enemy PC Management Change Processing)

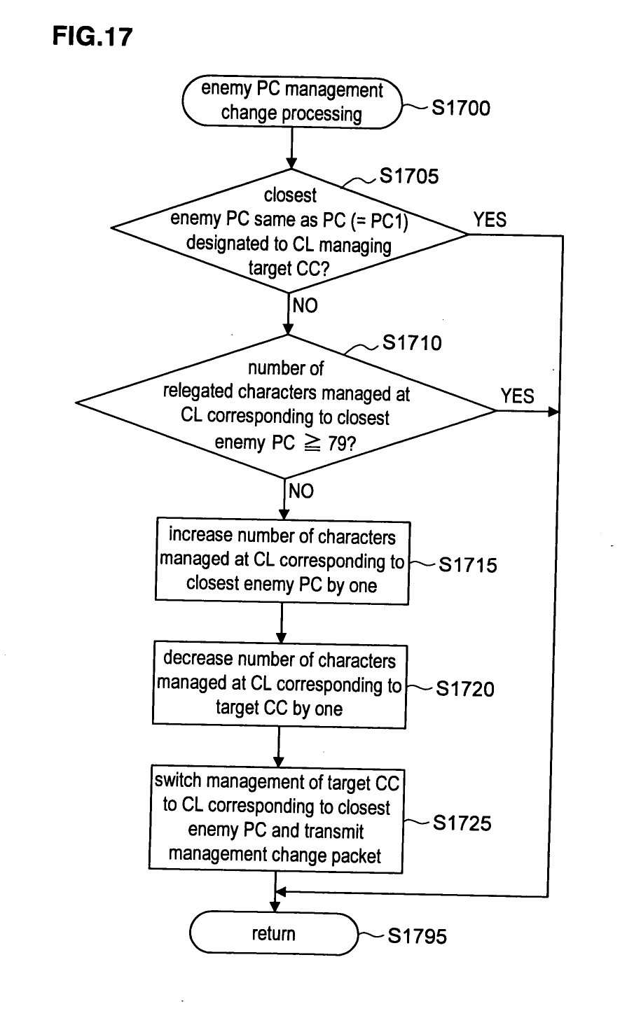

More specifically, as shown in FIG. 17 after the enemy PC management change processing starts in step 1700, the operation proceeds to step 1705 in which the decision-making unit 275 makes a decision as to whether or not the closest enemy PC (=PC3) is the PC (=PC1) manipulated through the game console 200 currently managing the target CC (=CC11). Since these player characters are not the same character, the decision-making unit 275 makes a negative decision in step 1705 and the operation proceeds to step 1710. In step 1710, the decision-making unit 275 makes a decision as to whether or not the game console corresponding to the closest enemy PC (=PC3) is currently managing 79 or more relegated characters. If the number of relegated characters managed at the game console that manages the PC3 is smaller than 79, the operation proceeds to step 1715 in which the number of relegated characters indicated in the character information corresponding to PC3 and stored in the RAM 220 is increased by one at the storage unit 255. Then the operation proceeds to step 1720, in which the number of relegated characters managed at the game console (CL) that manages the PC (=PC1) and also currently manages the target CC (=CC11) is decreased by one.

Subsequently, the operation proceeds to step 1725 in which the communication unit 280 transmits a management change packet containing information indicating a switch-over of the management of the target CC (=CC11) from the game console 200 that manages the PC1 to the game console 200 that manages the PC3 to the other game console 200 via the game server 100 and then the operation proceeds to step 1795 to end the processing. As described above, when both the ally PC2 and the enemy PC3 have moved close to the CC11, the management of the CC11 (relegated character) is switched to the game console managing the enemy PC3 with priority over the game console managing the ally PC2.

It is to be noted that as in the ally PC management change processing shown in FIG. 14, the operation proceeds to step 1795 to end the processing without switching the management of the relegated character if an affirmative decision is made either in step 1705 or in step 1710.

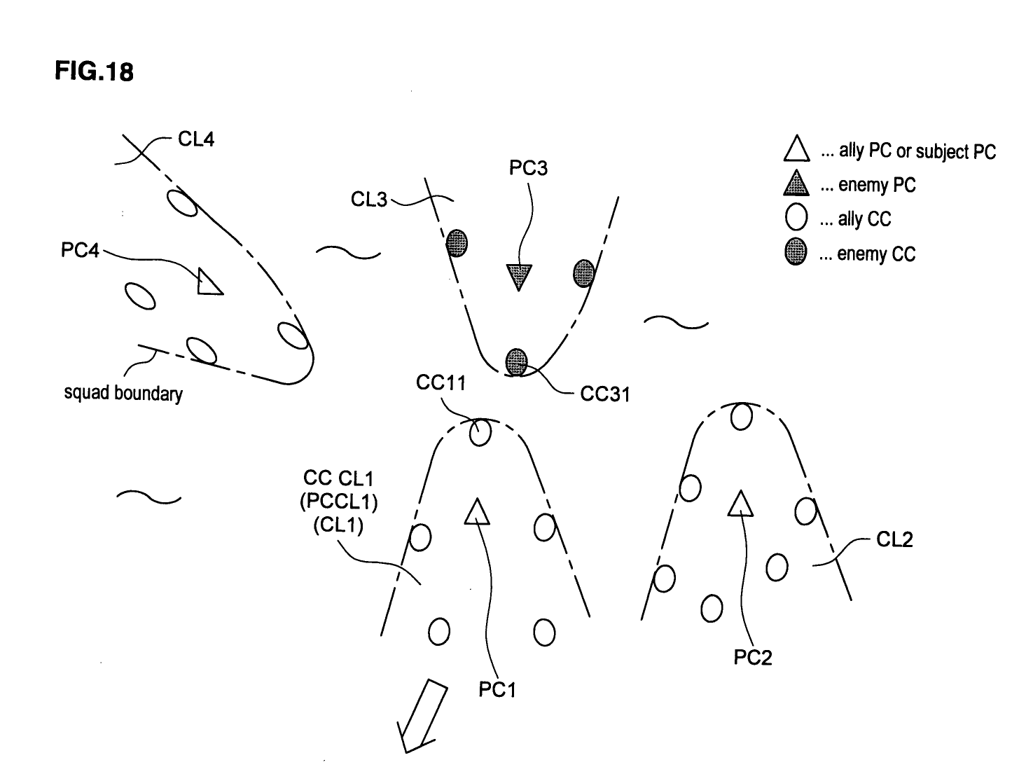

By the end of the processing, the management of the CC11 has been switched over to the PC3 game console, as shown in FIG. 15. An explanation is now given on a situation that develops as the game progresses to the state shown in FIG. 18 (i.e., the PC1 having moved close to the PC3 (see FIG. 15) moves slightly away from the PC3 (see FIG. 18)) after the management of the CC31 is switched over to the game console managing the PC1 through the execution of the character change decision-making processing in FIG. 10 executed by the game console 200 managing the PC3 over the vertical trace line interrupt interval

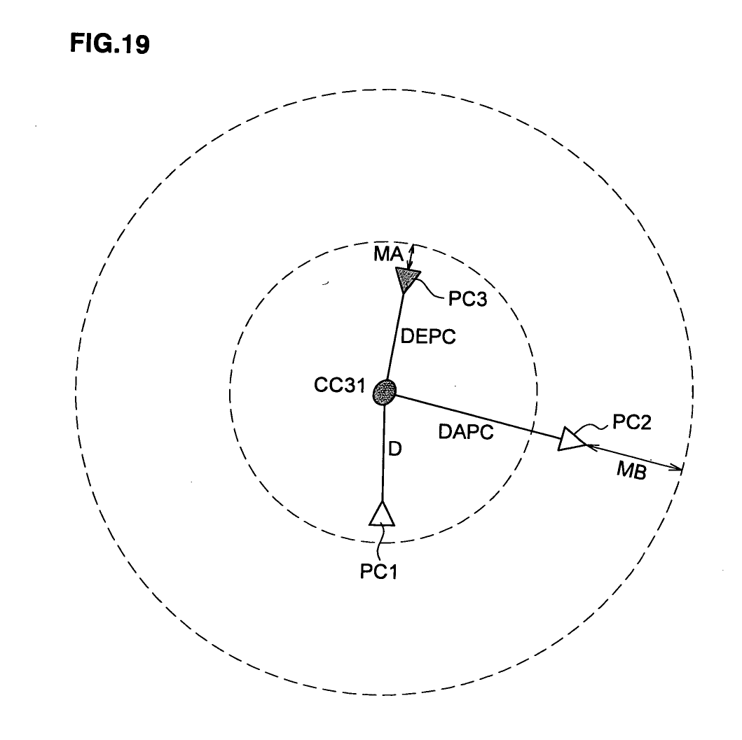

The positional relationship among the CC31, the subject PC1, the ally PC2 and the enemy PC3 in this situation is as shown in FIG. 19. As the character change decision-making processing shown in FIG. 10 is executed in this state, the decision-making unit 275 determines in step 1010 following steps 1000 and 1005 that the CC31 is an enemy of the PC (=PC1) manipulated via the game console managing the CC31. Accordingly, the operation proceeds to step 1050 in which the arithmetic operation unit 260a determines the distance D between the CC31 and the PC1. Next, in step 1055, the decision-making unit 275 makes a decision as to whether or not the value obtained by adding the margin MA to the distance DEPC is smaller than the distance D. At this point in time, the sum of the distance DEPC and the margin MA is greater than the distance D. Accordingly, the operation proceeds to step 1060 in which the arithmetic operation unit 260a determines the distance DAPC between the CC31 and the closest ally PC (=PC2).

Then, the operation proceeds to step 1065 in which the decision-making unit 275 makes a decision as to whether or not the value obtained by adding a margin MB to the distance DAPC is smaller than the distance D. At this point in time, the sum of the distance DAPC and the margin MB is greater than the distance D. Accordingly, the operation proceeds to step 1035 to make a decision as to whether or not the processing has been executed for all the relegated characters registered in the RAM 220. Until it is decided in step 1035 that all the relegated characters registered in the RAM have undergone the processing, the operation returns to step 1005 to repeatedly execute the change decision-making processing for the individual relegated characters.

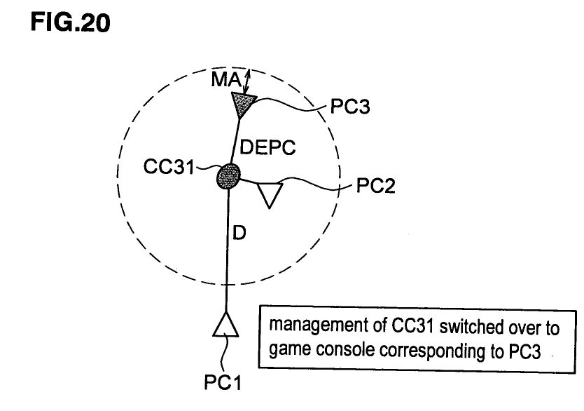

Next, an explanation is given on a situation such as that shown in FIG. 20, in which the ally PC2 and the enemy PC3 have moved closer to the CC31 with the enemy PC3 present at a position closer to the CC31 than the subject PC1 by an extent equal to or greater than the margin MA. As the character change decision-making processing in FIG. 10 is executed in this state, the decision-making unit 275 makes an affirmative decision (“YES”) in step 1055 following steps 1000 through 1010 and step 1050 and then the operation proceeds to step 1070 to execute the enemy PC management change processing shown in FIG. 17. Namely, by executing the processing in steps 1700 through 1725, the management of the CC31 is switched over from the game console 200 managing the PC1 to the game console 200 managing the PC3. As described above, when both the ally PC2 and the enemy PC3 are present at positions close to the CC31 and the enemy PC3 is closer to the CC31 than the subject PC1 by an extent equal to or greater than the margin MA, the management of the CC31 (relegated character) is switched over to the game console managing the enemy PC3 with priority over the game console managing the ally PC2.

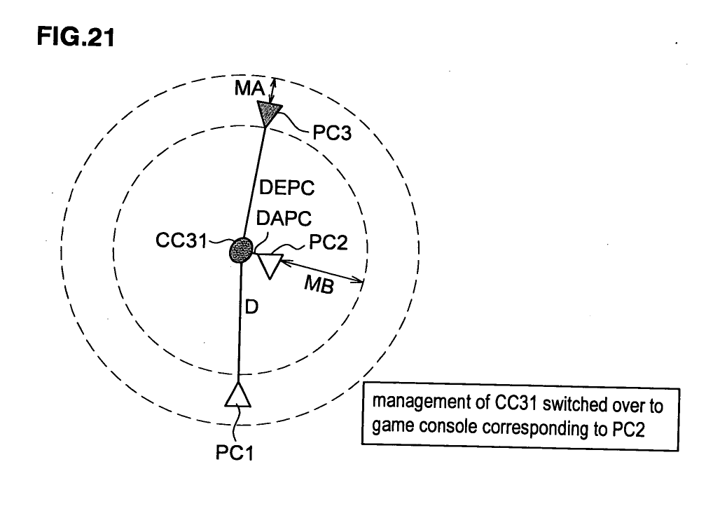

Now, an explanation is given on a situation that develops as the game shifts from the state shown in FIG. 19 to the state shown in FIG. 21 (i.e., the enemy PC3 is not present at a position closer to the CC 31 than the subject PC1 by an extent equal to or greater than the margin MA and the ally PC2 is present at a position closer to the CC31 than the subject PC1 by an extent equal to or greater than the margin MB). As the character change decision-making processing in FIG. 10 is executed in this state, the decision-making unit 275 makes an affirmative decision (“YES”) in step 1065 following steps 1000 through 1010 and steps 1050 through 1060 and then the operation proceeds to step 1040 to execute the ally PC management change processing shown in FIG. 14. Namely, by executing the processing in steps 1400 through 1425, the management of the CC31 is switched over from the game console 200 managing the PC1 to the game console 200 managing the PC3.

(Margin Settings)

The character change decision-making processing in FIG. 10 described above is executed in reference to the specific margins (margins MA, MB, MC and MD) set in correspondence to the specific type of PC (enemy PC or ally PC) manipulated via the game console to which the management of the target CC may be switched. These margins are set so as to ensure that even when the PC managed at another game console 200 is present at a position closest to a relegated character (the target CC) managed at the game console managing the subject PC, the decision-making unit 275 makes a decision that the subject game console 200 is to continuously manage the relegated character by disallowing frequent switch-over in the management, especially if the positional relationship among the characters is within a specific cutoff range, as long as the PC managed at the other game console 200 is not present at a position closer to the target relegated character than the player character managed at the subject game console 200 by an extent equal to or greater than a predetermined distance. Since a team combat game is an action game in which slight positional changes occur with extremely high frequency, it is crucial that control be executed so as to disallow excessively frequent switchovers of management and thus to allow the game to progress smoothly by reducing the load of the overall processing.

In addition, the margins MB, MC and MD each assume a value greater than the value of the margin MA, which is used in step 1055 when comparing the distance between the relegated character (target CC) undergoing the decision-making processing and the enemy PC and the distance between the target CC and the subject PC, and assumes a relatively small value so as to hand over the management of the target CC to the enemy PC relatively readily. Namely, the margin MA assumes a relatively small value so that the decision-making unit 275 is able to make an affirmative decision (“YES”) in step 1055 readily to execute the processing for switching the management of the target CC over to the enemy PC in step 1070.

The margins MB and MD, on the other hand, each assume a relatively large value, since they are respectively used in step 1065 and 1030 when comparing the distance between the relegated character (target CC) undergoing the decision-making processing and the ally PC and the distance between the target CC and the subject PC and the management of the target CC should not be switched over to the ally PC too readily. In other words, the margins MB and MD both assume a relatively large value so that the decision-making unit 275 does not make an affirmative decision (“YES”) in steps 1030 and 1065 too readily. Thus, the processing is executed so as to avoid a switch-over of the management of the target CC to an ally PC as much as possible.

In addition, the margin MC is set so as to ensure that when the PC managed at the other game console 200 is an enemy of the relegated character (the target CC) and the subject PC managed at the subject game console 200 and the enemy PC managed at the other game console 200 is present within a specific range (=margin MC) from the target CC, the management of the target CC is switched over to the other game console 200 regardless of the positional relationship (i.e., the positional relationship among the subject PC, the target CC and the enemy PC) having been determined. Namely, if the enemy PC is present within the specific range (=margin MC) from the target CC, the decision-making unit 275 makes an affirmative decision (“YES”) in step 1015 and the management of the target CC is switched over to the enemy PC with priority in step 1045.

A greater value is selected for the margin MB than the value selected for the margin MC for the following reasons. As explained earlier, a team combat game is an action game in which slight positional changes occur with extremely high frequency. In addition, since the position of each character calculated through the actual processing indicates a numerical value including decimals, even the character that appears to be completely stationary and in a standby state on the screen is very often judged to be constantly moving by a slight extent during the processing. To explain this point in further detail, the position of a character standing 50 meters away from a given point in the virtual space is indicated in the processing to be constantly fluctuating within the range of 49.9 meters through 50.1 meters. The range of the fluctuation increases as the game player manipulates the subject PC. Thus, as the squad belonging to the subject PC and the squad belonging to an enemy PC engage in combat at the position 50m away from the given point the positions of an extremely large number of characters fluctuate over the range around the position 50m away from the given point with extremely high frequency.

If the margin MB and the margin MC assume values equal to each other (=50), switchovers of relegated characters would occur too frequently. Let us consider a specific situation in which the target CC and the subject PC are fighting on the same side and the distance DEPC between the closest enemy PC and the target CC is 49. Under such circumstances, the decision-making unit 275 would make an affirmative decision (“YES”) in step 1015 following steps 1005 and 1010 and the management of the target CC would be switched over to the enemy PC in step 1045. Subsequently, if the enemy PC moves slightly away from the target CC, increasing the distance DEPC to 51, the decision-making unit 275 would make an affirmative decision (“YES”) in step 1065 following steps 1005, 1010 and 1050 through 1060 and thus, the management of the target CC would be switched over to the ally PC in step 1040. Subsequently, if the enemy PC moves slightly closer to the target CC, reducing the distance DEPC between the closest enemy PC and the target CC back to 49, the decision-making unit 275 would make another affirmative decision (“YES”) in step 1015 and the management of the target CC would be switched over to the enemy PC in step 1045. Different values are set for the margins MB and MC in order to prevent such excessively frequent character management switchovers (i.e., the margin MB is set to 60 and the margin MC is set to 50).

(Operation at Game Server)

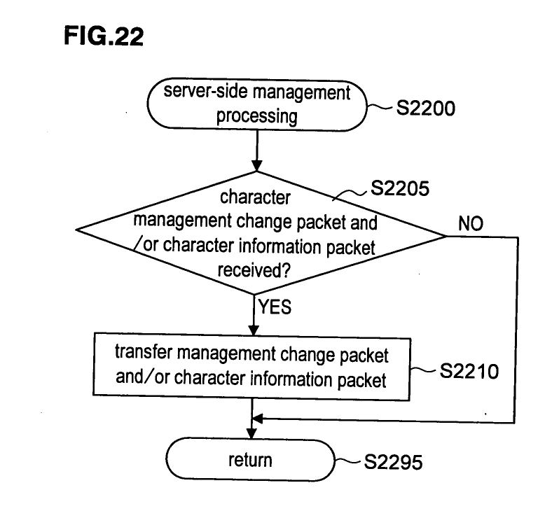

Next, the operation of the game server 100 is explained. As shown in the flowchart presented in FIG. 22, the processing at the game server 100 starts in step 2200. In step 2205, a decision is made as to whether or not a character management change packet and/or a character information packet has been received. If either packet has been received, the game server 100 transmits the character management change packet and/or the character information packet having been transmitted from the sender game console 200 to all the game consoles 200 except for the sender game console 200 in step 2210, and then the operation proceeds to step 2295 to end the processing. It is to be noted that while it is not necessary to store the character information corresponding to the individual characters at the storage unit 150 of the game server 100, the character information may be stored at the storage unit 150 anyway.

In the network game system achieved in the embodiment, the “action processing” which needs to be executed immediately during a combat game is delegated to the game consoles (on the client side) constituting user-side terminals. In addition, computer characters are each managed at one of the game consoles 200 in this game system. As a result, the processing load is not borne by the game server 100 alone and the processing load can be distributed over the entire system. Consequently, each game player is able to enjoy an exciting and realistic game with quick response without being aware of any communication delays.

In addition, if an enemy PC is present within a predetermined distance from the target CC being managed at the subject game console in a combat scene, control is executed so as to switch over the management of the CC to the game console managing the enemy PC with priority in the game system. Otherwise (if the enemy PC is not within the predetermined range, an ally PC is present at a position further away than a predetermined distance or no character is present within the predetermined distance), the management of the target CC is switched over to any PC moving to a position closest to the target CC, regardless of whether the new PC is an enemy or an ally.

The game player playing the network game remains less aware of communication delays if the management of enemy characters is delegated to his console with priority. In other words, in a combat situation in which PCs are engaged in combat in close proximity in the network game system 10 achieved in the embodiment, the game console managing the subject PC manages enemy CCs with priority. Under these circumstances, if the optimal decision cannot be made based entirely upon the enemy/ally factor (if a plurality of PCs on the same team are present within close range of one another), the decision as to which game console should be delegated to the management of the target CC is made based upon their distances to the CC. In addition, if the PCs are present at positions distanced from each other, a decision as to which game console should be delegated to the management of the target CC is made entirely based upon their distances to the target CC regardless of the enemy/ally factor.

In principle, the subject PC fights with an enemy CC present in its vicinity and does not engage in combat against an ally CC in the vicinity. For this reason, arithmetic processing is frequently executed for the subject PC and the enemy CC present in its vicinity at the game console managing the subject PC. Through the character management method described earlier, the management of the enemy CC is delegated to the game console 200 managing the subject PC with priority so as to execute the arithmetic processing that needs to be executed frequently completely within the subject game console. Since characters managed within a given game console can be processed without necessitating any network communication, the game console delegated to the management of the enemy CC with priority experiences fewer delays in communication. As a result, the motions of the characters on the screen change immediately in response to the operations by the individual game players. Since each game player is able to play quick-response combat against enemy guards (CCs) as if playing the game on a standalone-type console, he is thus bound to find the game even more engrossing.

It is to be noted that the character information corresponding to all the characters including characters managed at the other game consoles, instead of the character information corresponding to all the characters including the subject CCs and the subject PC (i.e., the subject squad) managed at each game console, is stored as data held within the memory such as the RAM in the client processing (game console-side processing), since characters managed at the other game consoles are likely to appear at the screen at the subject console and thus, the data consistency cannot be achieved unless the latest coordinate data and the like in the corresponding character information, at least, are stored. The latest coordinates of all the subject CCs and the subject PC managed at the subject console among all the characters are directly calculated based upon the change quantities resulting from key input operations or the like at the subject game console 200, are stored for data updates and then are transmitted to the other game consoles 200 via the game server 100 to achieve data consistency. Thus, the latest coordinates data updates processing for the coordinates of the characters managed at the subject console can be executed quickly. However, the latest coordinate data of characters managed at the other game consoles 200 need to be first obtained through calculation executed at the other game consoles, be received via the game server 100 and then be stored for data update to achieve data consistency. Thus, the latest coordinate data updates processing for the characters managed at the other game consoles is assumed to occur with a delay attributable to the communication delay.

However, the object of the embodiment is to speedily execute the processing for CCs managed at the subject console including an enemy CC having moved into close range. For this reason, this time lag is not detrimental and it is also assumed that the storage of the information indicating the states of all the characters at each game console does not compromise the visual quality of the game. The reason for the latter point is that the subject PC is displayed at a position slightly lower than the center of the screen in a typical team combat game (the visual field at each game console, i.e., the position and the angle of the point-of-view camera, is automatically set to an optimal value at the game console) and that it has been learned through experience that as long as processing related to the combat scene involving the subject squad on which the game player is bound to be focused is executed speedily, a slight delay in the motions displayed in the peripheral areas, i.e., areas where other squads managed at other game consoles are displayed will not bother the game player.

### Second Embodiment

Next, the network game system 10 achieved in the second embodiment is explained. The operational feature that the character change decision-making processing is executed at the game server 100 in the network game system 10 achieved in the second embodiment distinguishes it from the first embodiment in which the character change decision-making processing is executed at the individual game consoles 200. Accordingly, the network game system 10 achieved in the second embodiment is explained by focusing on this feature.

(Operations at Game Consoles)

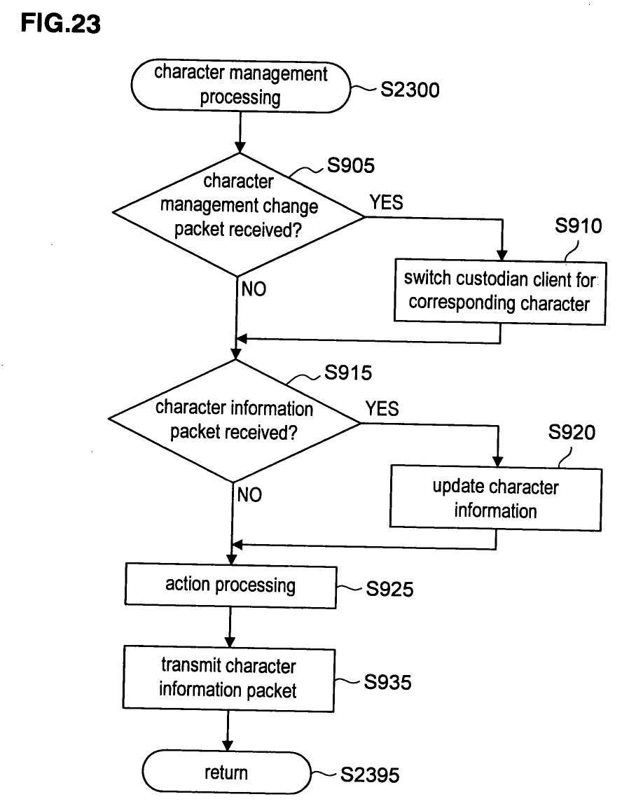

In the embodiment, the character management processing, which is part of the client-side management processing in FIG. 8 and is called up in step 815, starts in step 2300 in FIG. 23, and the processing in step 935 is executed and the operation proceeds to step 2395 to end the processing after executing the processing in steps 905 through 925. In other words, the character change decision-making processing in step 930 in FIG. 9, which is executed in the first embodiment, is not executed in this embodiment. In short, while the action processing is executed at the individual game consoles 200, the character change decision-making processing is not executed at the game consoles in the embodiment.

(Operation at Game Server)

In the embodiment, the game server 100 stores the character information for the individual characters shown in FIG. 7 into its RAM 120 in advance. Namely, the character management change decision-making is executed at the game server 100, with the character information shown in FIG. 7 all held at the RAMs of the game server 100 and the various game consoles 200.

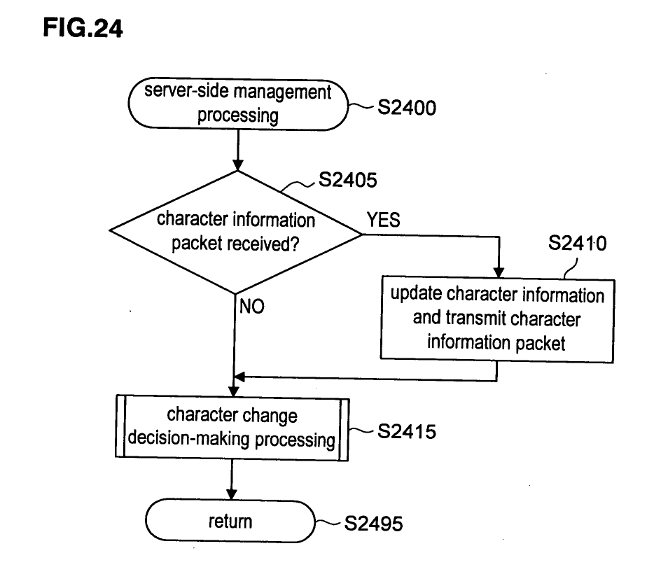

The processing at the game server 100 starts in step 2400, as shown in the flowchart presented in FIG. 24. In step 2405, the game server 100 makes a decision as to whether or not a character information packet has been received. If such a packet has been received, the game server 100 updates the character information of the corresponding character in the RAM 120 holding the character information, as shown in FIG. 7 by using the character information contained in the character information packet having been transmitted from the sender game console 200, and transmits the character information packet to all the game consoles 200 except for the sender game console 200 in step 2410. Then, the operation proceeds to step 2415 to execute the character change decision-making processing in FIG. 10. Following step 2415, the operation proceeds to step 2495 to end the processing. It is to be noted that in the first embodiment, the character change decision-making processing in FIG. 10 is repeatedly executed at each game console 200 for the individual relegated characters managed at the game console 200 among all the computer characters (CCs). In the second embodiment, on the other hand, the character change decision-making processing needs to be repeatedly executed for each of all the computer characters (CCs).

In the network game system 10 achieved in the embodiment, all the characters are managed at the game server 100. Theoretically, this means that substantially equal processing delays occur at the individual game consoles, as long as the communication environment including the distances from the game server 100 to the individual game consoles and the performance levels of the game consoles 200 is uniform and no communication failure occurs. Thus, numerous characters on the screen behave with natural motions. Furthermore, since the management for all the characters is executed at the game server 100, the consistency of the data can be sustained easily and accurately.

In addition, in a uniform communication environment such as that described above, the only factor that leads to a delay occurring as the character management is switched over is the length of time required for the communication between the game server 100 and the game consoles 200 in the embodiment. Thus, the extent of the delay occurring in the system achieved in the embodiment is reduced by half compared to the delay occurring at the other game consoles 200 in the event of a switch-over in the first embodiment in which the character management processing is executed at the subject game console 200.

As explained above, through the network game system 10 achieved in either of the embodiments, a condition in which the results of the interaction of characters managed at the subject game console 200 are immediately reflected on the screen is created through clever control under which “the action processing is delegated to the individual game consoles 200 by assigning the management of each character to a specific game console”, “the image of a relegated character managed at another game console is brought up on display at the subject game console with a slight delay” and “relegated characters managed at the subject game console are affected by the image of a relegated character managed at the other game console”. This feature is particularly effective in a network game in which a very large number of characters forming a plurality of squads engage in team combat.

It is to be noted that the closest PC is calculated by comparing the distances of all the PCs to the target CC in the embodiments described above.

In addition, in the character change management processing described above, the relative distances of the individual PCs to the relegated character (CC) are calculated and a decision is made as to whether or not the management of the character should be switched based upon the relationship among the calculated distances. However, the character change management processing in the embodiments may instead be executed by designating each CC present within a specific range from a given PC as a relegated character.

(Character Management Centered Around PC)

In such processing, the decision-making unit 275 at each game console 200 may determine that a single computer character (CC) or a plurality of computer characters (CCs) present within a first predetermined range around the player character (subject PC) managed at the subject game console 200 are to be managed at the subject game console 200 as its relegated characters based upon the extents of changes in the positions of the individual relegated characters are calculated at the arithmetic operation unit 260a.

When the player character (other PC) managed at another game console 200 and a given computer character (CC) are on opposing teams and the PC (subject PC) managed at the subject game console 200 and the target CC are on the same side, the decision-making unit 275 may determine that the target CC is to be managed at the other game console 200 as long as the computer character (CC) is present at a position within a second predetermined range from the enemy PC even if it is also located within the first predetermined range from the PC managed at the subject game console 200 in such PC-centered character management processing. In addition, the first predetermined range may be set smaller than the second predetermined range.

If the number of CCs present within a predetermined range around the PC is equal to or greater than a predetermined value, the management of the predetermined number of CCs may be switched. In addition, the management of the CCs may be switched over when a predetermined length of time elapses following the verification of the presence of CCs within the predetermined range around the PC in a number equal to or greater than the predetermined value.

In this case, in a combat situation in which a CC, an enemy PC and the subject PC are present within close proximity to one another, the management of the CC can be delegated to the game console 200 managing the enemy PC with priority, and thus, the processing for the overall game can be carried out smoothly.

### Third Embodiment

Next, the network game system 10 achieved in the third embodiment is explained. In principle, the subject PC and the CCs belonging to the subject squad are managed at the subject game console 200, an ally PC and ally CCs belonging to another squad led by the ally PC are controlled at a game console 200 through which the ally PC is manipulated, and an enemy PC and enemy CCs belonging to another squad led by the enemy PC are managed at a game console 200 through which the enemy PC is manipulated in the network game system 10 achieved in the third embodiment, as has been explained in reference to the first embodiment.

However, the operation executed in the embodiment differs from the operation executed in the first embodiment in that even when there are not enough game players participating in the game (e.g., even when a single game player is playing), the management principle described earlier is applied to the participating game player and in that a single PC or a plurality of PCs that cannot be manipulated by actual users as well as the CCs belonging to the squad(s) led by the PC(s) are automatically managed at the game server 100. Accordingly, the network game system 10 achieved in the embodiment is explained below by focusing on this difference.

It is to be noted that a player character (PC) managed at the game server 100 (SV) may also be referred to as a server character (SC). In addition, when a plurality of server characters are managed at the game server 100, the player character managed at a game console 200 or another server character managed at the game server 100, which is not the server character corresponding to the current target CC undergoing the character change decision-making processing may also be referred to as a main character (MC). The game console 200 or the game server 100 managing a main character may also be referred to as an MC managing device.

(Functional Structure of Game Server 100)

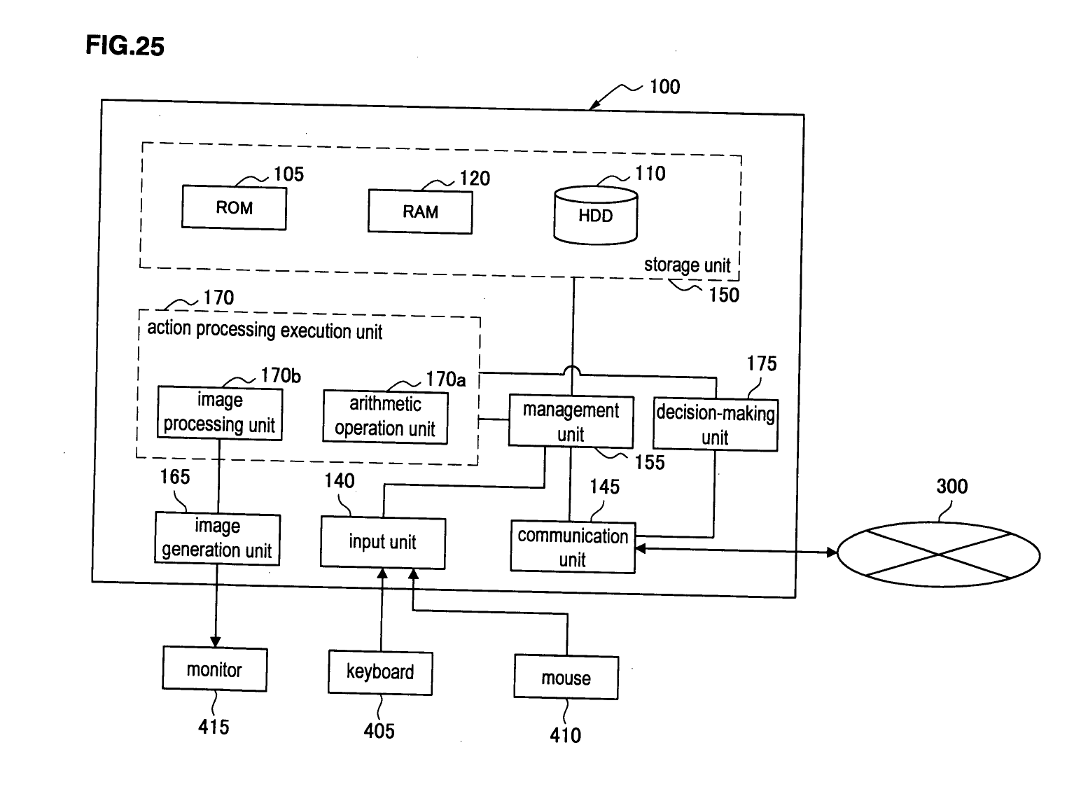

The game server 100 in the embodiment is equipped with functions represented by the functional blocks that include an arithmetic operation unit 170a and a decision-making unit 175, in addition to the functions of the game server 100 achieved in the first embodiment, as shown in FIG. 25. The function of an action processing execution unit 170 is realized through the arithmetic operation unit 170a and an image processing unit 170b.

Among the additional functions, the action processing on the individual relegated characters registered at the storage unit 150 and managed at the game server 100 is executed by the action processing execution unit 170 in correspondence to each of the relegated characters. More specifically, the arithmetic operation unit 170a generates updated character information by calculating the change quantities indicating the extents of changes in the position and the motion of each relegated character resulting from a combat sequence in the game based upon the character information stored at the storage unit 150.

In addition, the decision-making unit 175 determines the positional relationship among the position of a server characters (SC position) managed at the game server 100, the position of a main character (MC position) managed at an MC managing device and the position of a relegated character having undergone the action processing (the calculated CC position) based upon the value indicating the change in the position of the relegated character having been calculated at the arithmetic operation unit 170a and makes a decision as to whether or not to continuously manage the relegated character based upon the positional relationship thus ascertained. The positional relationship among “one of” the player characters managed at the game server 100, the MC position and the calculated CC position is determined, since the game server 100 needs to individually manage a plurality of server characters, i.e., a plurality of player characters not designated to any game consoles 200, when only a few users are participating in the game.

(Operation at Game Server 100)

In this embodiment, too, each game console 200 basically manages a subject player character and computer characters assigned to the management of the game console 200. More specifically, the characters are managed at the game console 200 by executing the client-side management processing shown in FIG. 8.

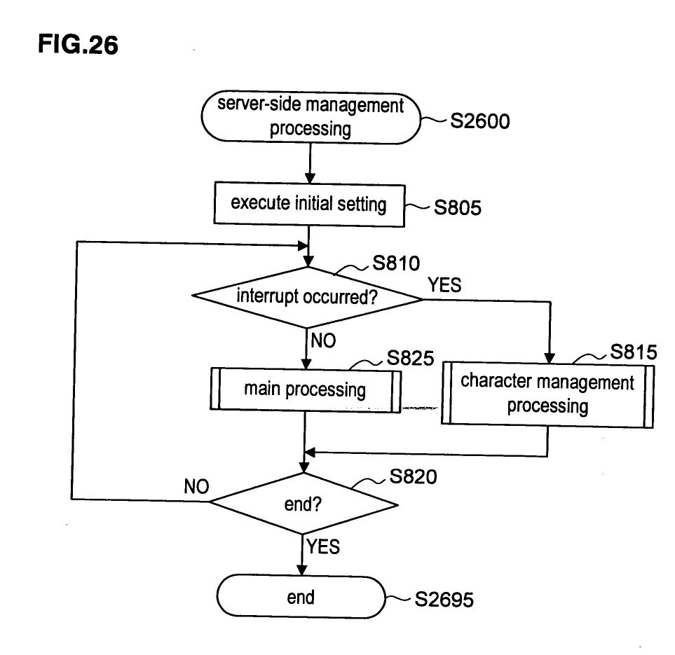

In addition, since the number of participating game players is small, a single server character or a plurality of server characters need to be automatically managed at the game server 100 in the embodiment. The single server character or the plurality of server characters and computer characters each assigned to the management at the game server 100 in correspondence to a specific server character are all managed at the game server 100. More specifically, these characters are managed through the server-side management processing executed at the game server 100, as shown in FIG. 26, instead of the client-side management processing executed at individual game consoles, as shown in FIG. 8.

It is to be noted that the operation executed at the game server 100, in principle, includes the operations having been explained in reference to the first and second embodiments, as well as the operation to be detailed below. In addition, it goes without saying that character management change packets and character information packets related to changes in the positions of an SC and a CC belonging to the squad led by the SC are not transmitted/received between the server (the packets are, however, transmitted/received as in the previous embodiments between the game server 100 and the game consoles 200) and instead, the character information (see FIG. 7) stored in the RAM 120 within the game server 100 is directly updated.

In the embodiment, only the actions of a player character that is not designated to a user are “automatically” managed at the game server 100 as the game progresses. This means that no display needs to be brought up at the monitor 415 at the game server 100 to enable server personnel to execute the action processing or that the server personnel do not need to enter any information via an input device such as the keyboard 405. In addition, processing for updating the information in the RAM 120 or sound processing, such as the processing executed in step 825 in FIG. 8 in the first embodiment, does not need to be executed in the embodiment. The operation of the game server 100 achieved in the embodiment is now explained on these premises.

(Game Start)

As the power to the game console 200 is turned on and a game player issues a game start request, the server-side management processing executed at the game server 100 starts in step 2600 in FIG. 26. In step 805, an initial setting operation is executed.

Next, in step 810, the decision-making unit 175 makes a decision as to whether or not an interrupt (vertical trace line interrupt (Vsync)) has occurred. The decision-making unit 175 makes an affirmative decision (“YES”) in step 810 as an interrupt occurs at the rate of once every 1/60 sec matching the length of the vertical trace line cycles at the monitor 415, and in this case, the operation proceeds to step 815 to execute character management processing (the character management processing is to be explained in detail later).

Next, the operation proceeds to step 820 in which the decision-making unit 175 makes a decision as to whether or not the game is to end. More specifically, the game ends if the game player turns off the power to the game console 200 or selects “game end” on the screen. Until the game player performs either of these operations, the game server 100 basically executes the processing in steps 810 through 820 repeatedly, and once the player performs either of the operations, the operation proceeds to step 2695 to end the game.

If an interrupt has not occurred, the decision-making unit 175 makes a negative decision (“NO”) in step 810, and in this case, the operation proceeds to step 825 to execute main processing. Once the main processing is executed, the operation proceeds to step 820. It is assumed that processing other than the processing bearing no direct relevance to the network game in the embodiment is also executed during the main processing.

(Character Management Processing)

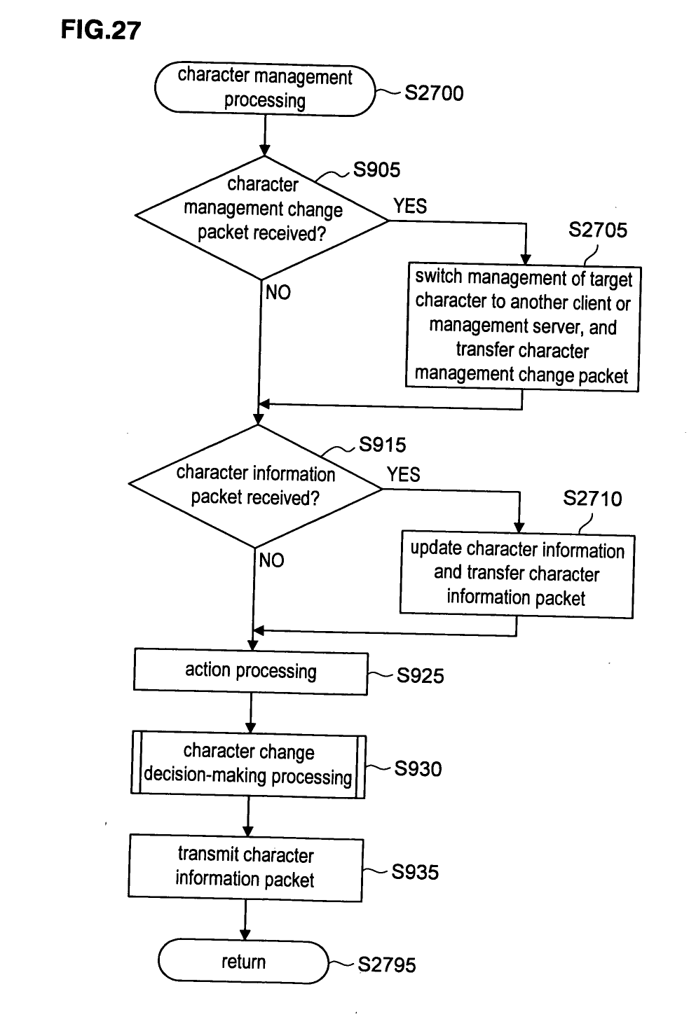

Next, the character management processing executed in step 815 is explained in reference to the flowchart presented in FIG. 27. After the processing starts in step 2700, the communication unit 145 makes a decision in step 905 as to whether or not a character management change packet transmitted from a participating game console 200 has been received.

If a character management change packet has been received, the operation proceeds to step 2705 in which the corresponding character information in the RAM 120 is updated at the storage unit 150 based upon the character information contained in the received character management change packet. More specifically, the information indicating the coordinates, the body orientation, the motion number, the reproduction frame position, the advancing direction and the team affiliation, which is stored as the character information for the corresponding PC or the corresponding CC in FIG. 7, is updated. In addition, the storage unit 150 registers the character identified in correspondence to the character information as a relegated character. Namely, the custodian PC number in the character information in FIG. 7 is altered, thereby switching the management of the relegated character either to the client-side (a game console 200) or the server-side (the game server 100). In step 2705, the character management change packet having been received is also transferred to all the other participating game consoles 200 via the communication unit 145.

Next, the operation proceeds to step 915 in which the communication unit 145 makes a decision as to whether or not a character information packet has been received from a participating game console 200. If a character information packet has been received, the operation proceeds to step 2710 in which the corresponding character information in the RAM 120 is updated at the storage unit 150 based upon the character information contained in the received character information packet. More specifically, the information indicating the coordinates, the body orientation, the motion number, the reproduction frame position, the advancing direction and the team affiliation, which is stored as the character information for the corresponding PC or the corresponding CC in FIG. 7 is updated. In addition, the character information packet having been received is also transferred to the other participating game consoles 200 in step 2710 via the communication unit 145.

Then, the operation proceeds to step 925 in which the action processing execution unit 170 executes action processing. The action processing specifically refers to the processing described below, which is executed at the individual units constituting the action processing execution unit 170. First, the arithmetic operation unit 170a obtains through arithmetic operation character information indicating change quantities that represent the extents of changes in the position and the motion of each relegated character based upon the character information stored in the RAM 120. Next, the image processing unit 170b issues an instruction for the image generation unit 165 for image generation by generating a parameter and a command whenever they become needed as the game progresses and outputting the parameter and the command to the image generation unit 165.

Next, the operation proceeds to step 930, in which the decision-making unit 175 executes character change decision-making processing (subroutine). Through this processing a decision is made with regard to the MC managing device (the game server 100 or a game console 200) best suited to manage the target relegated character based upon the positional relationship among the calculated position of the relegated character (CC), the position of the server character (SC) and the position of the main character (MC).

Then, the operation proceeds to step 935 in which the communication unit 145 transmits the character information for each of the relegated characters having been obtained through the arithmetic operation executed by the arithmetic operation unit 170a to the participating game consoles 200. As the information indicating the latest character states is transmitted to the participating game consoles 200, as described above, the character information for those characters stored in the other game consoles 200 is updated. Thus, the data consistency is maintained.

(Character Change Decision-Making Processing)

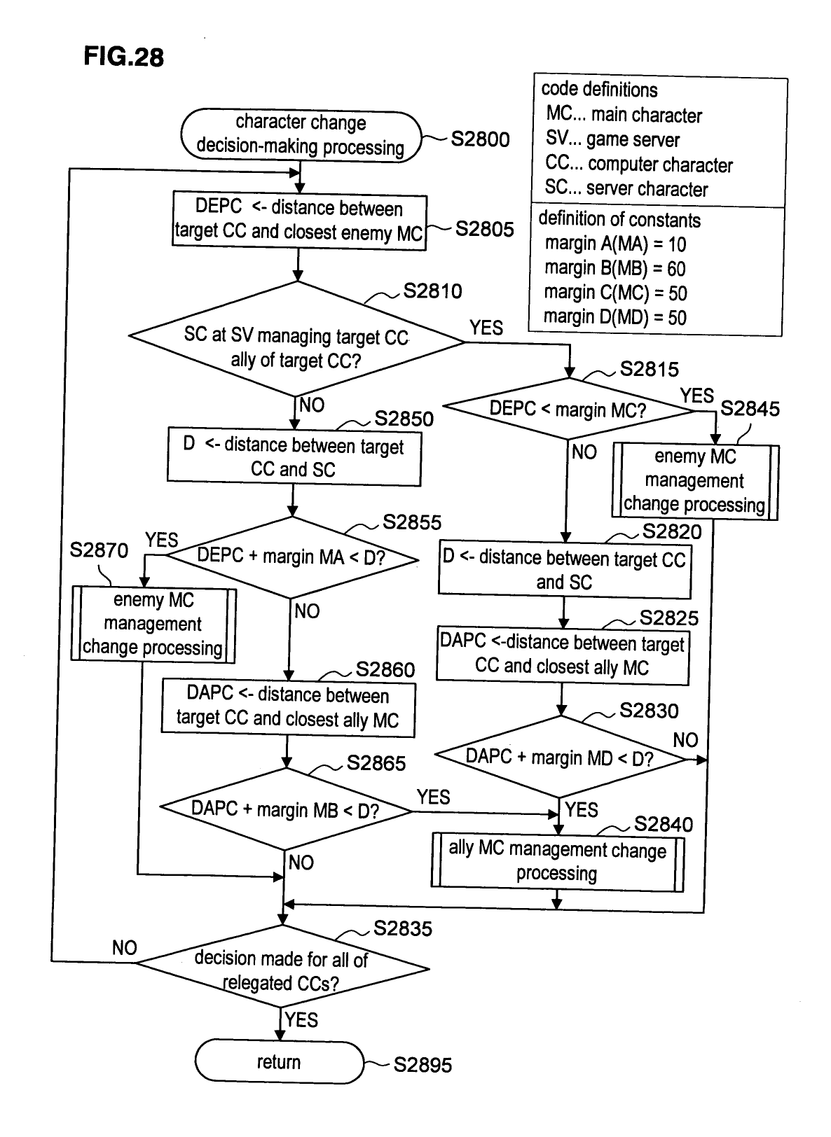

Next, the character change decision-making processing executed in step 930 is explained in detail in reference to FIG. 28.

After the character change decision-making processing starts in step 2800, the operation proceeds to step 2805, in which the arithmetic operation unit 170a determines the distance DEPC between a CC registered at the storage unit 150 as a relegated character and the main character (enemy MC) present at the position closest to the target CC, (namely, either an enemy PC or another SC closest to the target CC). “Another SC” refers to an SC other than the server character (SC) managed at the game server 100, which corresponds to the target CC undergoing the character change decision-making processing.

Then, the operation proceeds to step 2810 in which the decision-making unit 175 makes a decision as to whether or not the server character (SC) managed at the game server 100 (SV), which corresponds to the target CC undergoing the character change decision-making processing, is an ally of the CC. If the server character is an ally of the CC, the decision-making unit 175 makes an affirmative decision and the operation proceeds to step 2815 in which the decision-making unit 175 makes a decision as to whether or not the distance DEPC is smaller than a margin MC. If the distance DEPC is greater than the margin MC, the operation proceeds to step 2820 in which the arithmetic operation unit 170a determines the distance D between the CC11 and the server character, and then, the operation proceeds to step 2825 to determine the distance DAPC between the CC and the closest ally main character.

Next, the operation proceeds to step 2830 in which the decision-making unit 175 makes a decision as to whether or not the value obtained by adding the margin MD to the distance DAPC is smaller than the distance D. If the sum of the distance DAPC and the margin MD is greater than the distance D, i.e., if the closest ally main character is still outside the circle around the CC with a radius matching the difference between the distance D and the margin MD, the decision-making unit 175 makes a negative decision and the operation proceeds to step 2835 without switching the management of the CC to another device. In step 2835, a decision is made as to whether or not the character change decision-making processing has been executed for all the CCs currently in the custody of the game server (i.e., the relegated characters). Until it is decided in step 2835 that all the relegated characters have undergone the character change decision-making processing, the operation returns to step 2805 to continuously execute the change decision-making processing for the individual relegated characters. Once the change decision-making processing is completed, the processing ends in step 2895.

Next, an explanation is given on a situation in which the ally main character is present at a position closer to the CC than the SC by an extent equal to or greater than the margin MD. In this situation, the decision-making unit 175 makes an affirmative decision (“YES”) in step 2830 following steps 2800 through 2825, and the operation proceeds to step 2840 to execute ally MC management change processing.

(Ally MC Management Change Processing)

More specifically, after the ally MC management change processing starts in step 2900, the operation proceeds to step 2905 in which the decision-making unit 175 makes a decision as to whether or not the closest ally MC is the SC manipulated by the game server 100 (SV) currently managing the target CC. If these player characters are not the same character, the decision-making unit 175 makes a negative decision in step 2905 and the operation proceeds to step 2910. In step 2910, the decision-making unit 175 makes a decision as to whether or not the MC managing device (a CL or the SV) managing the closest ally MC is currently managing 79 or more relegated characters. If the number of relegated characters managed at the MC managing device that manages the closest ally MC is smaller than 79, the operation proceeds to step 2915 in which the number of relegated characters indicated in the character information corresponding to the closest ally MC stored in the RAM 120 is increased by one at the storage unit 150. Then the operation proceeds to step 2920, in which the number of relegated characters managed at the game server 100 currently managing the CC is decreased by one.

Subsequently, the operation proceeds to step 2925 in which the communication unit 145 transmits a management change packet containing information, which indicates a switch-over of the management of the target CC from the game server 100 managing the SC to the MC managing device managing the ally MC to the participating game consoles 200 and then the operation proceeds to step 2995 to end the processing. As described above, if the ally MC is present at a position closer to the CC than the SC by an extent equal to or greater than the margin MD, the management of the CC (relegated character) is switched over to the MC managing device that manages the ally MC.

It is to be noted that if it is decided in step 2905 that the closest ally MC is the SC manipulated through the game server 100 currently managing the target CC, the management of the relegated character does not need to be switched. In addition, if it is decided in step 2910 that the number of relegated characters currently managed at the MC managing device corresponding to the closest ally MC is equal to or greater than 79, the number of relegated characters managed at the particular game console should not increase any further. Accordingly, the management of the relegated character is not switched. In either case, the operation proceeds to step 2995 to end the processing.

Next, an explanation is given to the character change decision-making processing executed when the squad belonging to the SC, the squad belonging to an enemy MC and the squad belonging to an ally MC are all engaged in team combat. If the enemy MC, too, is present within the circle around the CC with a radius matching the margin MC while the CC is at the closest position to the ally MC, the character change decision-making processing starts in step 2800 in FIG. 28 and in step 2815 following steps 2805 and 2810, the decision-making unit 175 makes an affirmative decision (“YES”). Then, the operation proceeds to step 2845 to execute enemy MC management change processing.

(Enemy MC Management Change Processing)

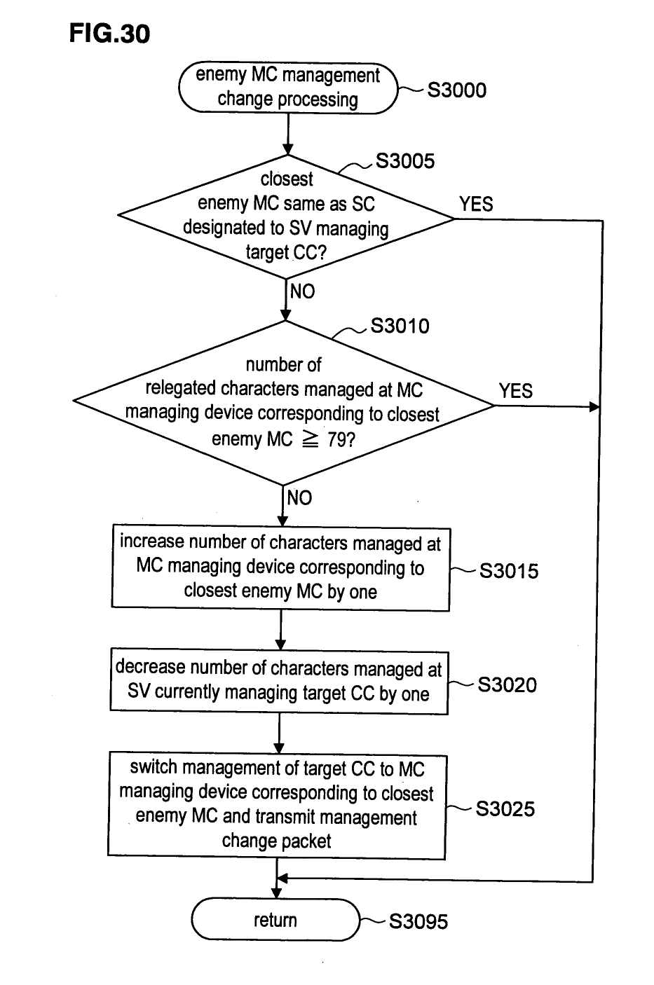

More specifically, after the enemy MC management change processing starts in step 3000, the operation proceeds to step 3005 in which the decision-making unit 175 makes a decision as to whether or not the closest enemy MC is the SC manipulated at the game server 100 currently managing the target CC, as shown in FIG. 30. Since the closest enemy MC is not the SC, the decision-making unit 175 makes a negative decision in step 3005 and the operation proceeds to step 3010. In step 3010, the decision-making unit 275 makes a decision as to whether or not the MC managing device corresponding to the closest enemy MC is currently managing 79 or more relegated characters. If the number of relegated characters managed at the MC managing device that manages the closest enemy MC is smaller than 79, the operation proceeds to step 3015 in which the number of relegated characters indicated in the character information on the MC corresponding to the MC managing device to take over the management of the CC, which is stored in the RAM 120, is increased by one at the storage unit 155. Then the operation proceeds to step 3020, in which the number of relegated characters managed at the game server 100 currently managing the CC is decreased by one.

Subsequently, the operation proceeds to step 3025 in which the communication unit 145 transmits a management change packet containing information, which indicates a switch-over of the management of the target CC from the game server 100 that manages the SC to the MC managing device that manages the enemy MC to the participating game consoles 200 and then the operation proceeds to step 3095 to end the processing. As described above, when both an ally MC and an enemy MC have moved close to the CC, the management of the CC (relegated character) is switched to the game console managing the enemy MC with priority over the game console managing the ally MC.

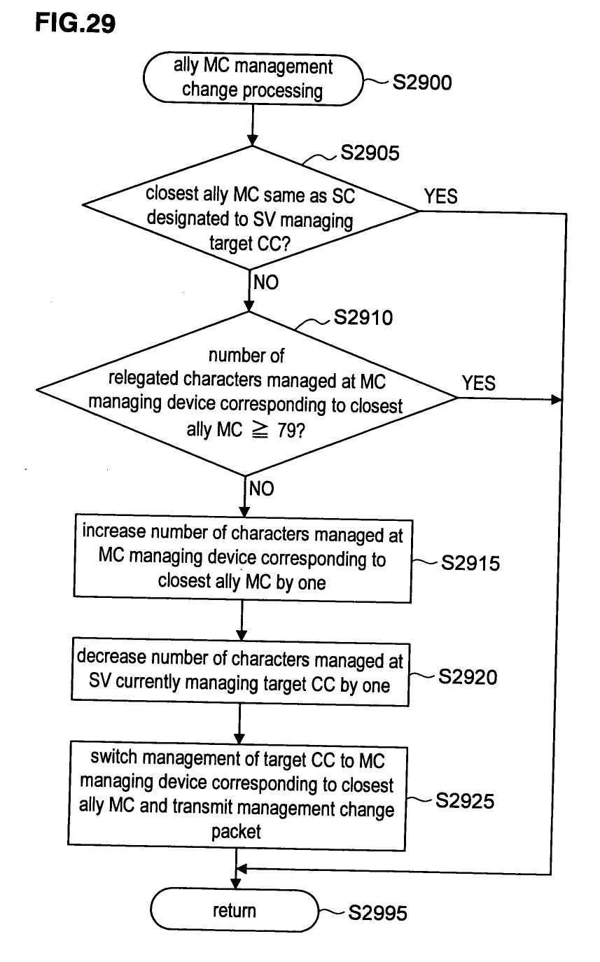

It is to be noted that as in the ally PC management change processing shown in FIG. 29, the operation proceeds to step 3095 to end the processing without switching the management of the target relegated character if an affirmative decision is made either in step 3005 or in step 3010.

Next, an explanation is given on the processing executed when the positional relationship among the CC (CC 31), the SC replacing the PC1, the ally MC replacing the ally PC2 and the enemy MC replacing the enemy PC3 is as shown in FIG. 19. As the character change decision-making processing shown in FIG. 28 is executed in this state, the decision-making unit 175 determines in step 2810 following steps 2800 and 2805 that the CC is an enemy of the SC manipulated via the game server 100 managing the CC. Accordingly, the operation proceeds to step 2850 in which the arithmetic operation unit 170a determines the distance D between the CC and the SC. Next, in step 2855, the decision-making unit 175 makes a decision as to whether or not the value obtained by adding the margin MA to the distance DEPC is smaller than the distance D. At this point in time, the sum of the distance DEPC and the margin MA is greater than the distance D. Accordingly, the operation proceeds to step 2860 in which the arithmetic operation unit 170a ascertains the distance DAPC between the CC and the closest ally MC.

Next, the operation proceeds to step 2865 in which the decision-making unit 175 makes a decision as to whether or not the value obtained by adding the margin MB to the distance DAPC is smaller than the distance D. At this point in time, the sum of the distance DAPC and the margin MB is greater than the distance D. Accordingly, the operation proceeds to step 2835 to make a decision as to whether or not the processing has been executed for all the relegated characters registered in the RAM 120. Until it is decided in step 2835 that all the relegated characters registered in the RAM 120 have undergone the processing, the operation returns to step 2805 to repeatedly execute the change decision-making processing for the individual relegated characters.

Next, an explanation is given on a situation such as that shown in FIG. 20, in which an ally MC replacing the ally PC2 and an enemy MC replacing the enemy PC3 have moved closer to the CC (CC31) with the enemy MC present at a position closer to the CC than the SC replacing the subject PC1 by an extent equal to or greater than the margin MA. As the character change decision-making processing in FIG. 28 is executed in this state, the decision-making unit 175 makes an affirmative decision (“YES”) in step 2855 following steps 2800 through 2810 and step 2850 and then the operation proceeds to step 2870 to execute the enemy MC management change processing shown in FIG. 30. Namely, by executing the processing in steps 3000 through 3025, the management of the CC is switched over from the game server 100 managing the SC to the MC managing device managing the enemy MC. As described above, when both an ally MC and an enemy MC are present at positions close to the CC and the enemy MC is closer to the CC than the SC by an extent equal to or greater than the margin MA, the management of the CC (relegated character) is switched over to the game console managing the enemy MC with priority over the game console managing the ally MC.

Next, an explanation is given on a situation that develops as the game shifts from the state shown in FIG. 19 to the state shown in FIG. 21 (i.e., the enemy MC replacing the enemy PC3 is not present at a position closer to the CC (CC 31) than the SC replacing the subject PC1 by an extent equal to or greater than the margin MA and the ally MC replacing the ally PC2 is present at a position closer to the CC31 than the SC replacing the subject PC1 by an extent equal to or greater than the margin MB). As the character change decision-making processing in FIG. 28 is executed in this state, the decision-making unit 175 makes an affirmative decision (“YES”) in step 2865 following steps 2800 through 2810 and steps 2850 through 2860 and then the operation proceeds to step 2840 to execute the ally MC management change processing shown in FIG. 29. Namely, by executing the processing in steps 2900 through 2925, the management of the CC is switched over from the game server 100 managing the SC to the MC managing device managing the ally MC.

As described above, even when a very small number of game players are participating in the game (e.g., when only one user is playing), the principle of the first embodiment (CCs are managed on the client side) is adopted in conjunction with the PC manipulated by each game player taking part in the game, and a single SC or a plurality of SCs unassigned to actual game players and CCs belonging to the squad(s) led by the SC(s) are basically managed automatically at the game server 100. As a result, even when only a few game players are participating in the game, the participating users are able to fully enjoy the game. In addition, since the character management is shared between the client devices and the server apparatus, the processing load in the overall system is shared among the client devices and the server apparatus to allow the game to progress smoothly.

(Character Management Centered Around SC)

In this embodiment, too, the decision-making unit 175 may determine that a single computer character (CC) or a plurality of computer characters (CCs) present within a first predetermined range around the SC managed at the game server 100 are to be managed at the game server 100 as its relegated characters based upon the extents of change in the positions of the individual relegated characters calculated at the arithmetic operation unit 170a.

When an MC managed at an MC managing device and a given CC are on opposing teams and the SC managed at the game server 100 and the target CC are on the same side, the decision-making unit 175 may determine that the target CC is to be managed at the MC managing device managing the MC as long as the CC is present at a position within a second predetermined range (first predetermined range <second predetermined range) from the MC even if the CC is also located within the first predetermined range from the SC managed at the game server 100 in such SC-centered character management processing.

If the number of CCs present within a predetermined range around the SC is equal to or greater than a predetermined value, the management of the predetermined number of CCs may be switched. In addition, the management of the CCs may be switched over when a predetermined length of time elapses following the verification of the presence of CCs within the predetermined range around the SC and a number equal to or greater than the predetermined value.

In this case, in a combat situation in which the CC, an MC and the SC are present within close proximity to one another, the management of the CC can be delegated to the MC managing device managing the MC with priority, and thus, the processing for the overall game can be carried out smoothly.

In addition, the management of a given CC managed at the game server 100 (SV) may be switched based upon the positional relationship among the position of the CC, the closest SC and the closest MC. For instance, the management of the CC may be switched if the distance between the CC currently managed at the game server 100 and the MC becomes smaller than the distance between the CC managed at the game server 100 and the SC.

The network game system 10 may also adopt a character structure in which the server characters and the computer characters managed at the game server 100 are assigned in specific relation to the enemy/ally designations among the player characters. Alternatively, all the server characters managed at the game server 100 may be designated as enemy characters, and all the player characters managed at the game consoles 200 may be designated as ally characters.

Furthermore, even when there is no shortage of game players, a server character and relegated characters (computer characters) automatically operated at the game server 100 may play a part in the game. In addition, a plurality of server characters automatically operated at the game server 100 may be designated to opposing teams, as well.

The operations executed at the individual units in the embodiments are correlated and accordingly, they may be regarded as a sequence of operations correlated to one another. By regarding the operations at the individual functional units as a series of operations, it is possible to embody the client device according to the present invention which manages characters as a character management method to be adopted in a client device.

Namely, the client device according to the present invention can be embodied as a character management method to be adopted in each of client devices connected with a server apparatus via a network and participating in a network game in which a plurality of characters including a plurality of player characters manipulated in conformance to information input through user operations and a plurality of computer characters which are manipulated automatically. This character management method comprises, individually storing into a storage unit of each client device character information containing position information indicating the positions of the plurality of characters, individually registering a computer character among all the computer characters to be managed at the subject client device as a relegated character at the storage unit of each client device and obtaining through an arithmetic operation updated character information indicating the extent of change in the position and motion of the relegated character as a game progresses.

In the client device adopting the character management method described above, further comprises, determining, based upon the extent of change in the position of each relegated character, the positional relationship among the calculated position of each relegated character, the position of the player character managed at the subject client device and the position of the player character managed at another client device, determining the client device to manage the relegated character based upon the positional relationship, clearing at the storage unit of the subject client device the registration of a relegated character with regard to which the management is determined to be delegated to the other client device and transmitting to the server apparatus a character management change packet containing the character information corresponding to the relegated character with regard to which the management has been determined to be delegated to the other client device.

Moreover, by regarding the operations executed at the individual units as a processing sequence executed at the individual units, the present invention may be embodied as a program. By storing the program in a computer-readable recording medium, the program can be embodied in the form of a computer-readable recording medium having the program recorded therein.

While the invention has been particularly shown and described with respect to preferred embodiments thereof by referring to the attached drawings, the present invention is not limited to these examples and it will be understood by those skilled in the art that various changes in form and detail may be made therein without departing from the spirit, scope and teaching of the invention.

For instance, the team combat game described in reference to the individual embodiments simply represents an example of a network game system. Other examples of network games include a social-climbing game, in which the subject player character is manipulated perform tasks to improve parameters such as the rank, the skills and the like of the subject player character in competition against other player characters manipulated via other client devices connected through a network. The system may instead offer a game through which communication is provided as a form of entertainment is provided as the player character manipulated by the subject game player, engages in a chat with another player character via a network.

Also, while an explanation is given in reference to the embodiments on an example in which up to eight game players can participate in the network game, the network game system according to the present invention is not limited to this example and it may be adopted in, for instance, a single game player mode in which the game is played on a single client device against the server apparatus.

Furthermore, when a small number of game players are participating in the game, any PCs not assigned to actual game players and the CCs belonging to the squads led by such PCs may all be redesignated as CCs so as to delegate the management of these CCs to the participating client devices (there may be only a single participating client device) through job sharing or to appoint the server apparatus as the manager of these CCs. In this situation, each of the PCs having been redesignated as CCs is no longer a character (PC) manipulated through user operations and, accordingly, it is processed as a CC within the system during the processing executed to determine the positional relationship.

The present invention may be adopted in a network game system with a plurality of characters taking part, in which the processing and the management of the individual characters are distributed so as to manipulate the characters smoothly, and a client device and the server apparatus constituting such a network game system.

What is claimed is:

1. A network game system in which a plurality of characters including a plurality of player characters manipulated in correspondence to information input by users each operating one of a plurality of client devices connected to a server apparatus via a network and a plurality of computer characters whose actions are automatically manipulated, wherein:
said client devices each comprise:
a storage unit for storing character information including position information indicating the positions of said plurality of characters, and registering computer characters to be managed at the subject client device among said computer characters as relegated characters;
an arithmetic operation unit for obtaining through arithmetic calculation updated character information indicating the extent of change occurring in the position of a relegated character and the extent of change occurring in the motion of said relegated character in correspondence to each of said relegated characters by using said character information stored at said storage unit as the game progresses; and
a communication unit for transmitting said updated character information corresponding to each relegated character having been obtained through said arithmetic calculation to said server apparatus as a character information packet;
said server apparatus receives the transmitted character information packet and transmits the received character information packet to other client devices participating in the game; and
said other client devices receive said transmitted character information packet and stores said updated character information based upon the received character information.

2. A network game system according to claim 1, wherein:
said client devices each further include;
a decision-making unit that determines based upon the extent of change in the position of each relegated character having been calculated, a positional relationship among the calculated position of said relegated character, the position of a player character managed at said subject client device and the position of a player character managed at another client device and makes a decision as to whether or not said relegated character is to be managed at said subject client device based upon the determined positional relationship, wherein:
said storage unit of said subject client device clears the registration of said relegated character if said decision-making unit decides that said relegated character is to be no longer managed at said subject client device;
said communication unit of said subject client unit transmits a character management change packet containing said character information for said relegated character to said server apparatus if said decision-making unit decides that said relegated character is to be managed at the other client device;
said server apparatus receives said character management change packet and transmits the received character management change packet to said other client device; and
upon receiving said character management change packet transmitted, said other client device stores the received character information and registers the character specified by the received character information as a relegated character.

3. A network game system according to claim 1, offering:
a combat game in which opposing teams made up of a plurality of characters including a plurality of player characters each managed at one of said plurality of client devices and computer characters aiding said plurality of player characters, engage in combat with one another.

4. A client device used to participate in a network game in which a plurality of characters including a plurality of player characters each manipulated in response to information input by users each operating one of a plurality of client devices connected via a network and a plurality of automatically-manipulated computer characters take part, comprising:
a storage unit for storing character information including position information indicating the positions of said plurality of characters, and registering computer characters to be managed at the subject client device among said computer characters as relegated characters; and
an arithmetic operation unit for obtaining through arithmetic calculation updated character information indicating the extent of change occurring in the position of a relegated character and the extent of change occurring in the motion of said relegated character in correspondence to each of said relegated characters by using said character information stored at said storage unit as the game progresses.

5. A client device according to claim 4, further comprising:
a decision-making unit for determining based upon the extent of change in the position of each relegated character having been calculated, a positional relationship among the calculated position of said relegated character, the position of said player character managed at said subject client device and a player character managed at another client device, and making a decision as to whether or not said relegated character is to be managed at said subject client device based upon the determined positional relationship.

6. A client device according to claim 5, offering:
a combat game in which opposing teams made up of a plurality of characters including a plurality of player characters each managed at one of said plurality of client devices and computer characters aiding said plurality of player characters, engage in combat with one another.

7. A client device according to claim 4, further comprising:
an image generation unit for generating, an image related to a character identified in the generated character information.

8. A client device according to claim 5, wherein:
said decision-making unit makes a decision as to whether or not each of said relegated characters is to be managed at said subject client device based upon the determined positional relationship so that the management of said relegated character is delegated to a client device managing a player character present at a position within a predetermined range from said relegated character.

9. A client device according to claim 6, wherein:
said decision-making unit makes a decision as to whether or not each relegated character is to be managed at said subject client device based upon the determined positional relationship so that the management of said relegated character is delegated with priority to a client device managing a player character assuming the role of an enemy of said relegated character.

10. A client device according to claim 6, wherein:
said decision-making unit makes a decision as to whether or not said relegated character is to be managed at said subject client device based upon the determined positional relationship so that said relegated character is managed at a client device managing a player character present at a position closest to said relegated character.

11. A client device according to claim 10, wherein:
said decision-making unit decides that the relegated character is to be continuously managed at said subject client device even when the position of said player character managed at said other client device is closest to said relegated character unless said player character managed at said other client device is closer to said relegated character than said player character managed at said subject client device by an extent equal to or greater than a specific distance.

12. A client device according to claim 11 wherein:
said specific distance is set to a value to be used as a margin that does not allow said decision-making unit to decide that the management of said relegated character is to be switched with excessive frequency.

13. A client device according to claim 12, wherein:
a smaller value is selected for said specific distance if said relegated character is an enemy to said player character managed at said other client device than a value set for said specific distance when said relegated character is an ally to said player character managed at said other client device.

14. A client device according to claim 6, wherein:
said decision-making unit makes a decision as to whether or not each of said relegated characters to be managed based upon said positional relationship having been calculated through said arithmetic operation, regardless of whether said relegated character is an enemy or an ally to said player character managed at said subject client device.

15. A client device according to claim 6, wherein:
said decision-making unit decides that the relegated character is to be managed at said other client device regardless of said positional relationship having been determined, if said player character managed at said other client device is an enemy to said relegated character and said player character managed at said subject client device and said player character managed at said other client device is present at a position within a predetermined range from said relegated character.

16. A client device according to claim 5, further comprising:
a communication unit for transmitting to said server apparatus a character management change packet containing character information corresponding to a relegated character with regard to which said decision-making unit has determined that said relegated character is managed at said other client device, wherein:
said storage unit clears the registration of said relegated character with regard to which said decision-making unit has determined that said relegated character is managed at said other client device.

17. A client device according to claim 16, wherein:
said communication unit receives a character management change packet transmitted from another client device connected to said server apparatus via the network; and
said storage unit stores character information contained in the received character management change packet, and registers a character specified in said character information as a relegated character.

18. A client device according to claim 6, wherein:
if a plurality of other client devices are connected via the network, a player character managed at a first other client device among said other client devices is an enemy and a player character managed at a second other client device is an ally, said decision-making unit makes a decision as to whether or not said relegated characters is managed at said subject client device based upon the determined positional relationship so that the management of said relegated character is delegated with higher priority to said first other client device than to said second other client device.

19. A client device according to claim 7, wherein:
said decision-making unit makes a decision as to whether or not each of said relegated characters is managed at said subject client device over predetermined intervals.

20. A client device according to claim 5, wherein:
the management of each computer character is relegated to one of said client devices participating in said network game.

21. A network game system according to claim 1, offering:
a game in which said plurality of player characters managed at said plurality of client devices and said plurality of computer characters are designated to teams that work in cooperation with one another.

22. A server apparatus that manages a network game in which a plurality of characters including a plurality of player characters and a plurality of computer characters take part, comprising:
a storage unit for storing character information including position information indicating the positions of said plurality of characters managed at a plurality of client devices connected to a network;
a decision-making unit for determining, based upon said position information contained in said character information, a positional relationship among the positions of said player characters managed at each client device and the position of a computer character managed at a client device, and making a decision with regard to a client device best suited to be delegated to manage said computer character based upon the determined positional relationship; and
a communication unit for transmitting a character management change packet to said client device having been determined as said client device to manage said computer character.

23. A character management program for executing a network game in which a plurality of characters, including a plurality of player characters manipulated in response to information input by users each operating one of a plurality of client devices connected to a network and a plurality of automatically-manipulated computer characters take part, comprising:
a module for individually storing into a storage unit of each client device character information including position information indicating the positions of said plurality of characters;
a module for registering each computer character among said computer characters to be managed at a subject client device as a relegated character at said storage unit of each subject client device; and
a module for obtaining through an arithmetic operation updated character information indicating the extent of change in the position and motion of said relegated character as the game progresses by using said character information stored in said storage unit of each subject client device.

24. A character management program according to claim 23, further comprising:
a module for determining based upon the extent of change in the position of each relegated character calculated, a positional relationship among the calculated position of said relegated character, the position of a player character managed at said subject client device and the position of a player character managed at another client device and determining said client device to manage said relegated character based upon said positional relationship;
a module for clearing at said storage unit of said subject client device the registration of a relegated character with regard to which the management has been determined to be delegated to said other client device; and
a module for transmitting to a server apparatus a character management change packet containing character information corresponding to said relegated character with regard to which the management has been determined to be delegated to said other client device.

25. A computer-readable storage medium having stored therein a character management program for executing a network game in which a plurality of characters, including a plurality of player characters manipulated in response to information input by users each operating one of a plurality of client devices connected to a network and a plurality of automatically-manipulated computer characters take part, the character management program comprising:
a module for individually storing into a storage unit of each client device character information including position information indicating the positions of said plurality of characters;
a module for registering each computer character among said computer characters to be managed at a subject client device as a relegated character at said storage unit of each client device; and
a module for obtaining through an arithmetic operation updated character information indicating the extent of change in the position and motion of said relegated character as the game progresses by using said character information stored in said storage unit of each client device.

26. A computer-readable storage medium having stored therein said character management program according to claim 25, further comprising:
a module for determining based upon the extent of change in the position of each relegated character calculated, a positional relationship among the calculated position of said relegated character, the position of a player character managed at said subject client device and the position of a player character managed at another client device and determining said client device to manage said relegated character based upon said positional relationship;
a module for clearing at said storage unit of said subject client device the registration of a relegated character with regard to which the management has been determined to be delegated to said other client device; and
a module for transmitting to a server apparatus a character management change packet containing character information corresponding to said relegated character with regard to which the management has been determined to be delegated to said other client device.

27. A network game system in which a plurality of characters including a single player character or a plurality of player characters manipulated in response to information input through user operations of a single client device or a plurality of client devices connected to a server apparatus via a network and a plurality of automatically-manipulated computer characters take part, wherein:
said client devices each comprise:
a storage unit for storing character information including position information indicating the positions of said plurality of characters, and registering computer characters to be managed at the subject client device among said computer characters as relegated characters;
an arithmetic operation unit for obtaining through arithmetic calculation updated character information indicating the extent of change occurring in the position of each relegated character and the extent of change occurring in the motion of said relegated character by using said character information stored at said storage unit as the game progresses; and
a communication unit for transmitting said updated character information corresponding to each relegated character having been obtained through said arithmetic calculation to said server apparatus as a character information packet;
said server apparatus receives the transmitted character information packet and transmits the received character information packet to other client devices participating in the game; and
said other client devices receive the transmitted character information packet and stores updated character information based upon the received character information.

28. A network game system according to claim 27, wherein:
said server apparatus comprises:
a storage unit for storing character information including position information indicating the positions of said plurality of characters, and registering computer characters to be managed at said server apparatus among said computer characters as relegated characters;
an arithmetic operation unit for obtaining through arithmetic operation updated character information indicating the extent of change occurring in the position of each relegated character and the extent of change occurring in the motion of said relegated character by using said character information stored at said storage unit as the game progresses; and
a communication unit for transmitting said updated character information corresponding to each relegated character having been obtained through said arithmetic calculation to all said client devices participating in the game as a character information packet.

29. A network game system according to claim 28, wherein:
said plurality of characters taking part in the game include a single server character or a plurality of server characters automatically manipulated under control executed by said server apparatus;
said server apparatus further comprises:
a decision-making unit for determining, based upon the extent of change in the position of each relegated character having been calculated through said arithmetic operation, a positional relationship among the calculated position of each relegated character, the position of one of said server characters managed at said server apparatus and the position of said player character managed at a client device or another server character, and making a decision based upon said positional relationship determined whether or not to manage said relegated character at said server apparatus to said one server character;
said storage unit of said server apparatus clears the registration of a relegated character with regard to which said decision-making unit of said server apparatus has determined that said relegated character is no longer to be managed at said server apparatus;
said communication unit of said server apparatus transmits a character management change packet containing character information corresponding to said relegated character to said client device to which said decision-making unit of said server apparatus has decided to delegate management of said relegated character; and
upon receiving said character management change packet transmitted, said client device stores the received character information and registers said character identified by the received character information as a relegated character.

30. A network game system according to claim 29, offering:
a combat game played by a single player character or a plurality of player characters managed at said single client device or said plurality of client devices and a single computer character or a plurality of computer characters aiding the single player character or the plurality of player characters, which make up an ally team, and a single server character or a plurality of server characters managed at said server apparatus and a single computer character or a plurality of computer characters aiding said server characters, which make up at least either an enemy team or an ally team.

31. A character management program for executing a network game in which a plurality of characters, including a single player character or a plurality of player characters manipulated in response to information input through user operations of a single client device or a plurality of client devices connected to a server apparatus via a network and a plurality of automatically-manipulated computer characters take part, comprising:
a module for individually storing into a storage unit of each client device character information including position information indicating the positions of said plurality of characters;
a module for registering each computer character among said computer characters to be managed at a subject client device as a relegated character at said storage unit of each client device; and
a module for obtaining through an arithmetic operation updated character information indicating the extent of change in the position and motion of said relegated character as the game progresses by using said character information stored in said storage unit of said subject client device.

32. A character management program according to claim 31 further comprising:
a module for individually storing into a storage unit of said server apparatus character information including position information indicating the positions of said plurality of characters;
a module for registering each computer character among said computer characters to be managed at said server apparatus as a relegated character at said storage unit of said server apparatus; and
a module for obtaining through an arithmetic operation updated character information indicating the extent of change in the position and the motion of each relegated character as a game progresses by using said character information stored at said storage unit of said server apparatus.

33. A character management program according to claim 32, wherein:
said plurality of characters taking part in the game further include a single server character or a plurality of server characters automatically manipulated under control executed by said server apparatus;
said character management program further comprising:
a module for determining, based upon the extent of change in the position of each relegated character having been calculated, a positional relationship among the calculated position of each relegated character, the position of one of said server characters managed at said subject server apparatus and the position of a player character managed at a client device and making a decision based upon said positional relationship determined that said relegated character is managed at said server apparatus in correspondence to one server character or by said client device;
a module for clearing the registration of a relegated character, the management of which has been determined to be delegated to said client device at said storage unit of said server apparatus; and
a module for transmitting a character management change packet containing character information corresponding to said relegated character, the management of which has been determined to be delegated to said client device, to said client device.

34. A character management program according to claim 33, offering:
a combat game played by a single player character or a plurality of player characters managed at said single client device or said plurality of client devices and a single computer character or a plurality of computer characters aiding the single player character or the plurality of player characters, which make up an ally team, and a single server character or a plurality of server characters managed at said server apparatus and a single computer character or a plurality of computer characters aiding said server characters, which make up at least either an enemy team or an ally team.
